(19) United States
(12) Patent Application Publication
(10) Pub. No.: US 2026/0122591 A1
(43) Pub. Date: Apr. 30, 2026

(54) MULTIPOINT-TO-MULTIPOINT OFDMA SYNCHRONIZATION PROCESSING FOR STREAM-BASED SYSTEMS

(71) Applicant: Fraunhofer-Gesellschaft zur Förderung der angewandten Forschung e.V., München (DE)

(72) Inventors: Matthias KOEPP, Berlin (DE); Kai HABEL, Berlin (DE)

(21) Appl. No.: 19/431,632

(22) Filed: Dec. 23, 2025

Related U.S. Application Data
(63) Continuation of application No. PCT/EP2024/068520, filed on Jul. 1, 2024.

(30) Foreign Application Priority Data
Jun. 30, 2023 (WO) PCT/EP2023/068128

(51) Int. Cl. H04W 56/00; H04L 27/26

(52) U.S. Cl. CPC H04W 56/001; H04L 27/26132

(57) ABSTRACT

A communication device is provided for multipoint-to-multipoint OFDMA communication. The device is configured to receive and transmit OFDMA signals, and specifically to receive a periodic synchronization signal, and to derive a transmission characteristic on the basis of the received synchronization signal and to adapt a subsequent transmission to the derived transmission characteristic.

### CROSS-REFERENCE TO RELATED APPLICATIONS

This application is a continuation of co-pending International Application No. PCT/EP2024/068520, filed Jul. 1, 2024, which is incorporated herein by reference in its entirety, and additionally claims priority from International Application No. PCT/EP2023/068128, filed Jun. 30, 2023, which is also incorporated herein by reference in its entirety.

### TECHNICAL FIELD

The invention refers to techniques for OFDMA commutations, in particular for multipoint to multipoint communications

### BACKGROUND

### Description of the Usage Environment “Multipoint-to-Multipoint OFDMA”

Orthogonal Frequency Division Multiplex (OFDM) and Orthogonal Frequency Multiple Access (OFDMA) enable highly efficient data transmissions compared to conventional Frequency Division Multiplex (FDM) or Frequency Divisional Multiple Access (FDMA), respectively. In OFDM and FDM systems, frequency resources are used by only one single device at a time, whereas OFDMA and FDMA enable the use of frequency resources by different devices at the same time.

The use of orthogonal frequency-modulating access systems (OFDM/A or OFDMA) is already in the prior art. OFDM/A systems divide a broadband signal into numerous orthogonal narrowband signals, called subcarriers. Advantages of OFDM/A systems over classical systems without orthogonal frequency modulation are known and may, among other things, be summarized as follows:
a) Spectral efficiency through modulation of signals on sub-carriers which do not require guard bands due to orthogonality and which are able to overlap while adhering to orthogonality conditions.
b) Subcarriers may be equalized in the frequency domain with low effort.
c) Spectral efficiency through individual selection of modulation depth and proportional transmission power per subcarrier.
d) DSP resource efficiency through common demodulation of all sub-carrier channels by means of FFT as well as common modulation of all locally assigned sub-carriers by means of IFFT
e) Spectral efficiency through common temporal guard intervals of all channels
f) Fine-granular allocation of channel capacity proportions in OFDMA systems with the possibility to dynamically adjust them during operation.
g) Dynamic rate adjustment with respect to changed channel conditions or changed transmission requirements (e.g. robustness of the transmission vs. transmission rate) during operation.

These advantages are brought, among other things, by significantly higher frequency and time synchronization requirements between transmitters and receivers. Insufficient synchronicity leads to signal transmission quality losses—and therefore to a decreased spectral efficiency—which may already become significant for relatively small values [21] [22]. These should be minimized.

OFDMA systems in widespread use today are point-to-multipoint (P2MP) systems (e.g. 5G mobile communications in the downstream) or multipoint-to-point (MP2P) systems (e.g. 5G mobile communications in the upstream). Inherently, all signals pass a central node (e.g. 5G base station, the “P” side) that either carries out synchronization tasks or supports the synchronization of the distributed system nodes (5G user terminals, the “MP” side) (The mere fact of having dedicated central receivers already supports the synchronization in today's OFDMA systems, as will be clarified below.) Typically, the synchronization of a P2MP- and MP2P-OFDMA duplex system (e.g. 5G system) takes place independently for each duplex direction (directions: upstream and downstream) which are separated by guard bands (in Frequency Division Duplex=FDD) or guard times (in Time Division Duplex=TDD). It is not required to adhere to orthogonality conditions between these bands. An OFDMA implementation for just one duplex direction is also possible (e.g. the upstream in DOCSIS 3.1 system). Among others, [22] shows methods for these systems.

Multipoint-to-multipoint (MP2MP) systems do not have a dedicated upstream and downstream: communication takes place directly between distributed devices. Pure OFDM systems allocate all orthogonal frequency resources (all usable subcarriers) at the same time to one network device (e.g. G.9960/G.9961). Synchronization information is transmitted along and is evaluated by receiving devices (e.g. in the G.9960 frame preamble). The adherence to orthogonality conditions between the frequency resources of simultaneously communicating devices is therefore inapplicable. Among others, [21] and [23] show methods for such systems.

The invention enables the creation of the synchronicity required between frequency resources used by different transmitters, to be kept orthogonal in MP2MP-OFDMA systems at all possible receiver positions inside the communication channel at the same time for preserving the possibility of correct decoding.

There is no MP2MP-OFDMA system marketed today, to the best of the inventors' knowledge; the synchronization required for OFDM/A techniques is realized exclusively in MP2MP-OFDM systems, or P2MP-OFDMA or MP2P-OFDMA systems, respectively.

The biggest similarity exists with respect to MP2P-OFDMA systems where the orthogonality conditions have to be adhered to only at the central node (“P”). However, the system envisaged here is to fulfill the orthogonality conditions at each point within the channel for decoding at this location.

### SUMMARY

An embodiment may have a communication device for multipoint-to-multipoint OFDMA communication, configured to receive and transmit OFDMA signals, wherein the communication device is configured to receive a periodic synchronization signal, wherein the communication device is configured to derive a transmission characteristic on the basis of the received synchronization signal and to adapt a subsequent transmission to the derived transmission characteristic.

According to another embodiment, a system for multipoint-to-multipoint OFDMA communication may have: a master communication device; and N client communication devices, with N≥1, wherein the N communication devices are configured to receive and transmit OFDMA signals, wherein the master communication device is configured to transmit the periodic synchronization signal and the N client communication devices are configured to receive the periodic synchronization signal; wherein each of the N client communication devices is configured to derive a transmission characteristic on the basis of the received synchronization signal and to adapt a subsequent transmission to the derived transmission characteristic, wherein the master communication device and each of the N client communication devices is further configured: to generate, for each OFDMA symbol of the sequence of OFDMA symbols, an initial cyclic extension in which there are copied the last samples of the OFDMA symbol, and/or to generate, for each OFDMA symbol of the sequence of OFDMA symbols, a final cyclic extension in which there are copied the first samples of the OFDMA symbol, in such a way that there is inserted a number of samples, in the initial and/or final cyclic extension, which require a time length which covers both: a first propagation delay from the master communication device to the client communication device which, among the N client communication devices, is the most remote from the master communication device; and a second propagation delay from the communication device which, among the N client communication devices, is the most remote from the master communication device, to the master communication device.

### BRIEF DESCRIPTION OF THE DRAWINGS

FIG. 1 shows an implementation according to an example;

FIG. 2 shows a technique according to OFDMA;

FIG. 3A shows an implementation according to an example;

FIG. 3B shows an implementation (which may be the same of that of FIG. 3A) according to an example;

FIG. 3C shows an implementation of a master device according to an example;

FIG. 3D shows an implementation of a master device according to an example;

FIG. 3E shows an implementation of a client device according to an example;

FIG. 4A shows an implementation (which may be the topics 3A and 3B) according to an example;

FIG. 4B shows an implementation according to an example (which may be the same of FIGS. 3A, 3B and 4A;

FIG. 5 shows an example according to the prior art;

FIGS. 6, 7, 8, 9, 10, 11, 12 and 13 shows operation according to examples;

FIGS. 14, 15, 16A, 16B, 16C, 16D, 167E, 16F, 16G show operations according to examples;

FIG. 17 shows an example of a multipath;

FIG. 18 shows an operation according to an example;

FIGS. 19A, 19B, and 19C show examples of operations;

FIGS. 20A and 20B show variants of elements of FIGS. 3A-4B; and

FIGS. 21A-21C show examples of operations.

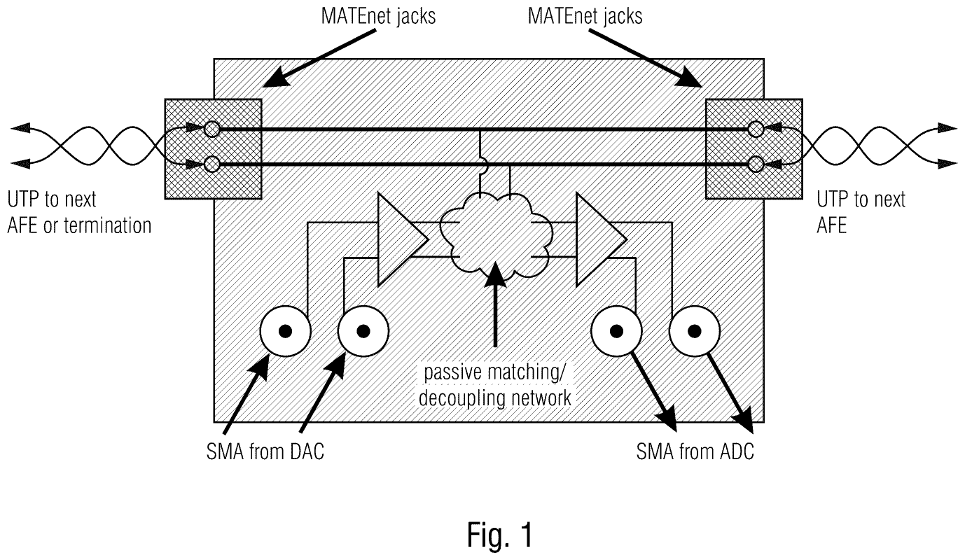

### DETAILED DESCRIPTION

### Description of the Devices Enabling the Multipoint-to-Multipoint OFDMA Synchronization

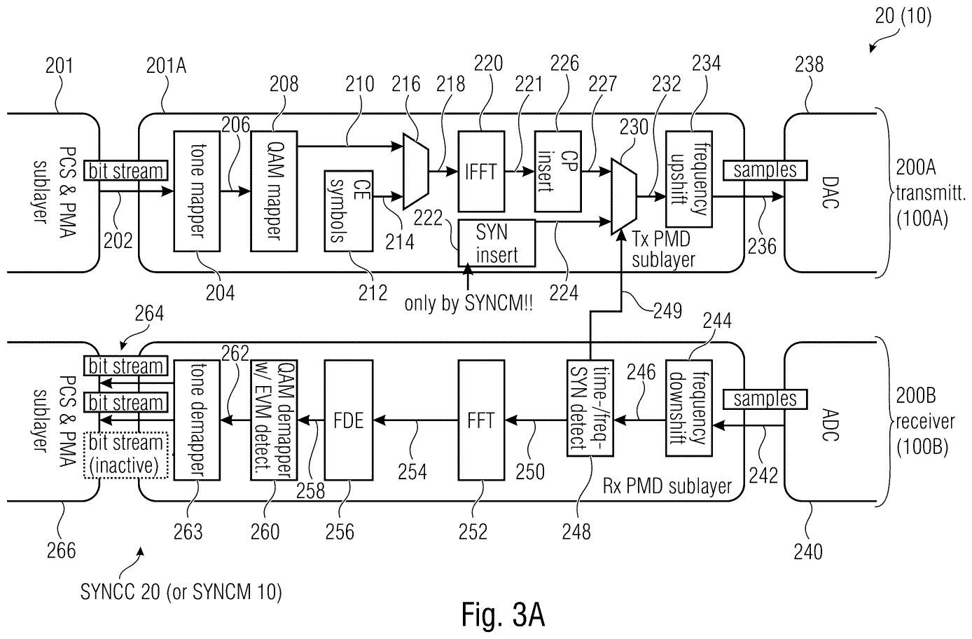

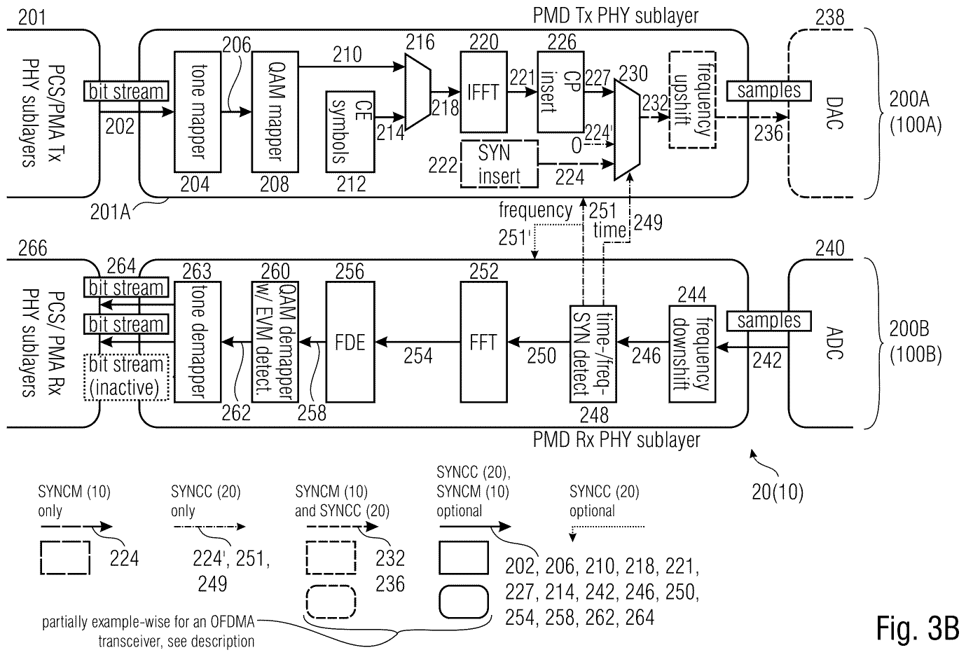

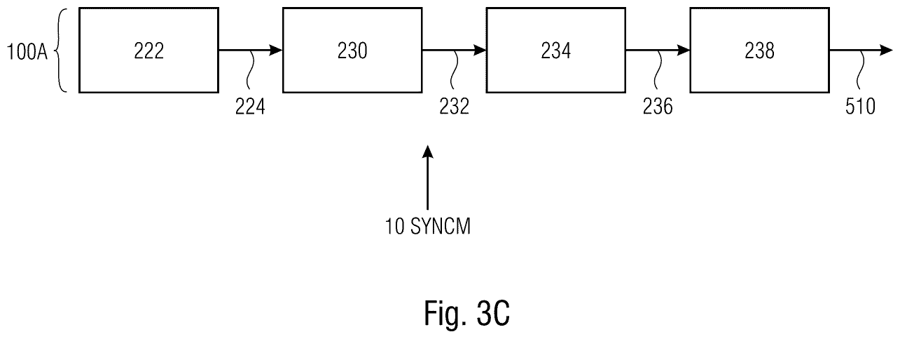

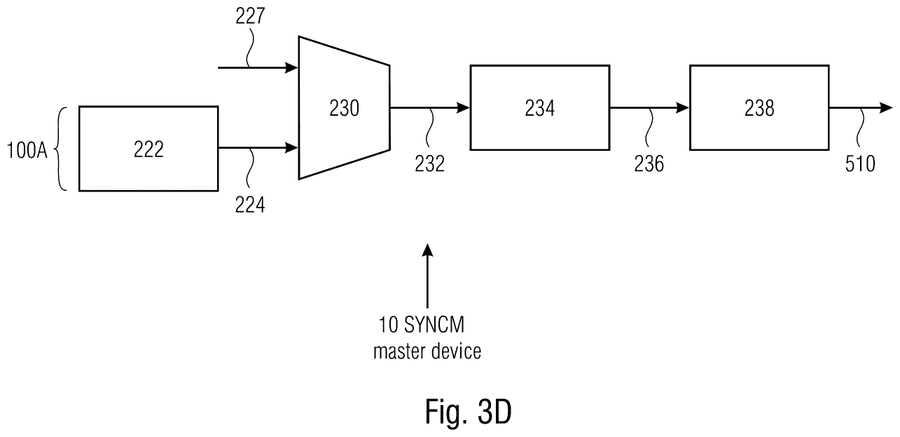

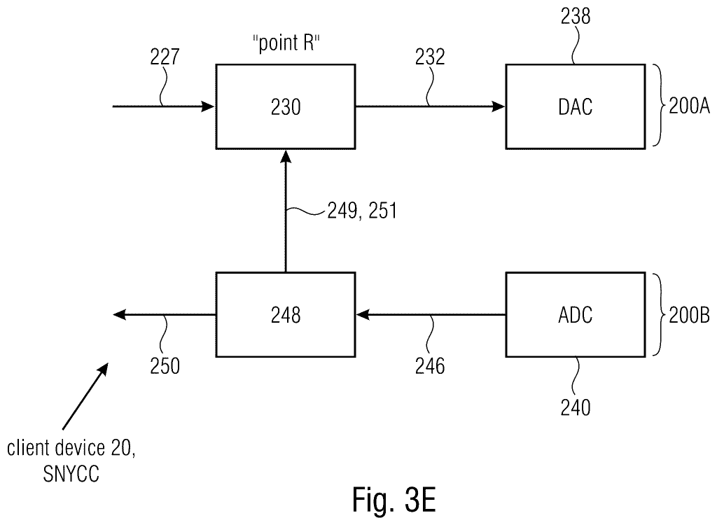

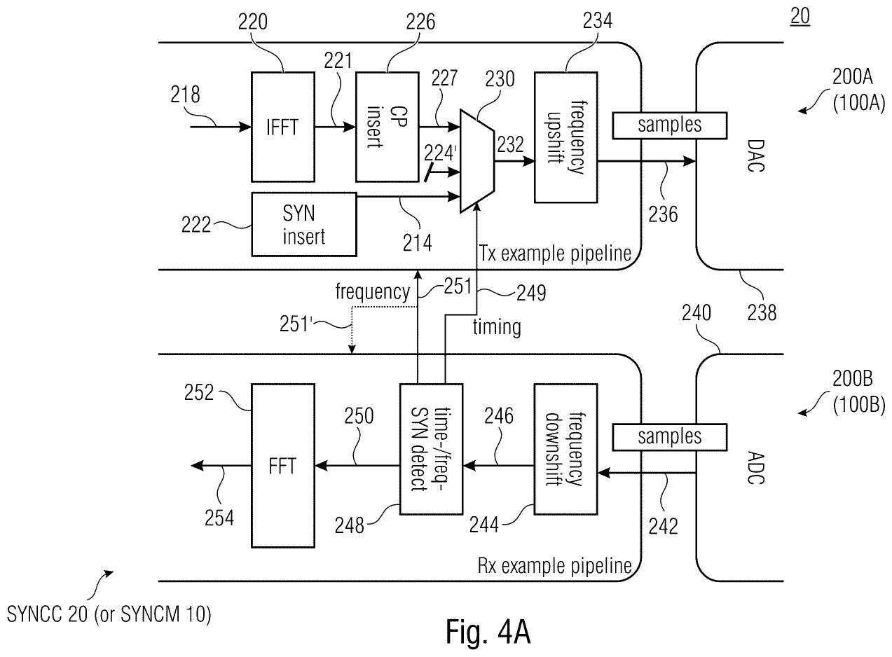

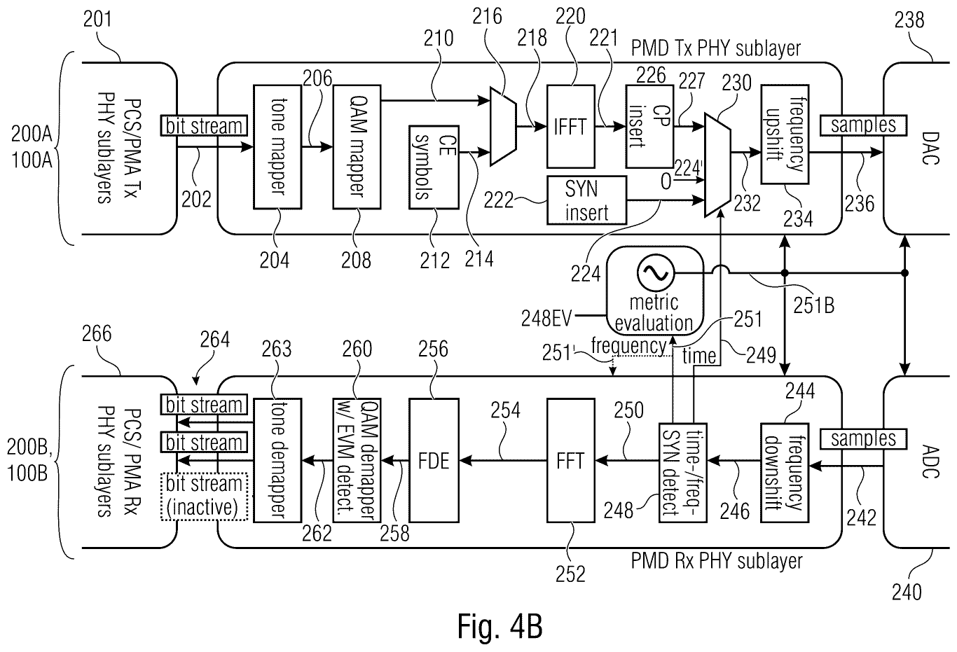

FIG. 3D shows an example of a synchronization master (SYNCM) device 10 in minimum configuration. A synchronization signal insertion block (or synchronization signal generation block) 222 generates a synchronization sequence (SYN) 224 which will be periodically transmitted as synchronization signal 510 through blocks 230 (a time-triggered or event-triggered gate with multiple inputs, which can also be called multiplexer, also indicated as “point R”), 234 (frequency upshift block, optional), and 238 (digital to analog converter 238) and through paths 232 and 236 (see also below). All the blocks of FIG. 3D form a transmitter side 100A. FIG. 3C shows no higher-layer data communication capability of the master device 10 and no reception capability (which notwithstanding may be carried out, see FIGS. 3A, 3B, 4A and 4B). FIG. 3D shows the master device 10 with data communication capabilities: communication data 227 are multiplexed at timing synchronization block 230 with the synchronization sequence 224. The receiver side 100B of the master device 10 can be avoided but, if present, can be as in any of FIGS. 3A, 3B, 4A, and 4B. In FIG. 3C, block 230 can be called a time-triggered or event-triggered gate with one single input (224), controlled by the internal clock of the master device 10.

FIG. 3E shows an example of a synchronization client (SYNCC) device 20 (also called client device 20 or client communication device 20) which is synchronized by the master device 10. A receiver side (pipeline) 200B receives through an analog to digital converter (ADC) 240 signals 246 received from other client devices and/or from the master device 10. The received signals 246 are subsequently processed from path 250 (see also FIGS. 3A, 3B, 4A, and 4B). The client device 20 receives data 227 to be transmitted at block 230 (timing synchronization control block, or time-triggered or event-triggered gate, also indicated as point “R”), and transmits them through path 232 to a DAC 238.

Among the received signals 246, the client device 20 also receives the synchronization signal 510 generated (as synchronization sequence 224, or SYN) by the master device 10 and provides it to a block 248 which may be a time and frequency synchronization detection block 248. From the synchronization signal 510, the time and frequency synchronization detection block 248 may derive a transmission characteristic (e.g. timing, frequency, sample clock, carrier, or a combination of them) on the basis of the received synchronization signal 510. Transmission characteristic information (e.g. timing 249 and/or frequency 251) may therefore be derived (e.g., by block 248) to adapt subsequent transmissions 232 to the new timing, thereby synchronizing client's subsequent transmissions 232 to the received synchronization signal 510 received from the master device 10.

We see therefore that both the master device 10 and the client device 20 have a “point R” (corresponding to gate 230), which operates as a gate in which the signals are fired. In the client device 20, the timing of the gate 230 is controlled by the timing transmission characteristic (249) as extracted by the time and frequency synchronization detection block 248. If frequency synchronization is to be achieved by the present examples too, the frequency (sampling frequency and/or carrier frequency) of block 230 is controlled either directly in block 230 by the frequency transmission characteristic (included as an example in FIG. 3E where the block may include corresponding functions), or indirectly, e.g. by adjusting its run speed together with the run speed of its environment (in FIG. 3E: 238 and the source or sources of 227) to compensate for sampling frequency offset (SFO) and/or carrier frequency offset (CFO) if the system scenario and implementation allows for, or e.g. to forward this information to the corresponding block to compensate for the frequency offset (non-exclusively, a frequency shift block as e.g. 234 might compensate for an externally generated signal carrier frequency). In the master device 10, the timing/frequency of the gate 230 is controlled by its internal clock. In the following, reference is mostly made to FIGS. 3A, 3B, 3C, and 3D, which notwithstanding may be embodiments of FIGS. 3C and 3D (in the case of master device) or FIG. 3E (in the case of client device).

The present examples generally use the two different kinds of devices (or two devices used with different operational modes), the synchronization client (SYNCC) device 20 and the synchronization master (SYNCM) device 10.

The SYNCC 20 implements an OFDMA data transmitter (transmitting pipeline) 200A and an OFDMA data receiver (receiver pipeline) 200B to transmit and receive data not utilized for data transmission and reception. In examples, it might implement OFDMA data transmission up to the data transmission path 227 as depicted in FIGS. 3a and 3b, 4a and 4b: It pre-codes data 202 to be transmitted inside the higher physical sublayers (physical coding sublayer (PCS), physical medium attachment (PMA), 201), passing it to the lower physical sublayer (physical medium dependent, PMA). The notation of the sublayers PCS, PMA, and PMD is widely spread in literature and standards to data transmission and reception (in example: ITU-T G.9960). The processing blocks and paths 202 to 227, and 212 and 214, show a typical example OFDM and OFDMA transmitter, where it is pointed out below, that block 226 has to be configured accordingly for the invention. Further, the paths 232 to 238 belong to the example OFDMA transmitter, finally passing the modulated data as analog data to the physical MP2MP channel by DAC 238 to the channels analog front end (AFE; e.g. containing amplifiers and/or bus channel taps or antennas or photo transmitters and/or further components), to superpose the so encoded data with corresponding data from other communication devices of the same kind. Optionally, analog device in the AFEs or analog devices inserted in between the DAC 238 and the AFE or digital device inserted into path 236 also can frequency upshift a signal in the transmitter and thus can substitute block 234 or modify its function further. Same counts for the receiver side and the AFE, block 240, path 242 and block 244, correspondingly. This mirrors into CFO detection (see below) correspondingly. Thus, it is pointed out that the basic OFDMA transmitter and receiver is an example implementation and compensating for CFO then should be taken into account at the corresponding reference clock.

On the receiver side 200B, the SYNCC 20 implements a data reception path, that might, in example, look like the path from FIGS. 3a, 3b, 4a, and 4b, 200B, by paths and blocks 240 to 266, to recover data transmitted from e.g. 201 by transmitter equipped devices, which superposed their signals on the physical channel. The path 249 and block 230 (time-triggered or event-triggered gate or multiplexer in the master device 10, timing synchronization control block or time-triggered or event-triggered gate in the client device 20) are described below.

The SYNCM 10 may implement a full data transmission and a data reception path like described above for the SNYCC 20 for data communication. This kind of device is called data communication enabled SYNCM in the further description. It implements the block 222 (synchronization signal insertion block, synchronization signal generation block) and the paths 224, 232, 236 and blocks 224 234, 238. A variant of a master device solely implementing these blocks (like in FIG. 3C) can be called minimum SYNCM implementation in the further description. Block 222 (synchronization signal insertion block, synchronization signal generation block) may contain a memory or may be a real-time processing block, providing a synchronization sequence (SYN) 224 (which will be transmitted as 510), allowing the SYNCC 10 to extract time and/or frequency synchronization information described below. Some examples of such sequences 224 are known from prior art, e.g. [24, 25, 26], and can either be stored or processed, in time domain or in frequency domain. Thus, it is pointed out that shifting such blocks and paths (222, 224 and 230) in front of an IFFT-block (220, or generally: an Inverse Discrete Fourier Transform (IDFT) block implementation) belonging to the data transmitter can be understood as being basically the same implementation, as well as reuse of any other block of an implemented OFDMA transmitter maintaining a fixed processing time for the time instant the sequence is generated by, modified by or passed through such blocks, either in same configuration as for data generation or in a different reconfiguration for carrying out synchronization data (e.g. the CP insertion block 226, the CE symbol generator 212 or the general QAM mapper 208 in the example implementation in FIGS. 3A, 3B, 4B, as well as 4A for block 226).

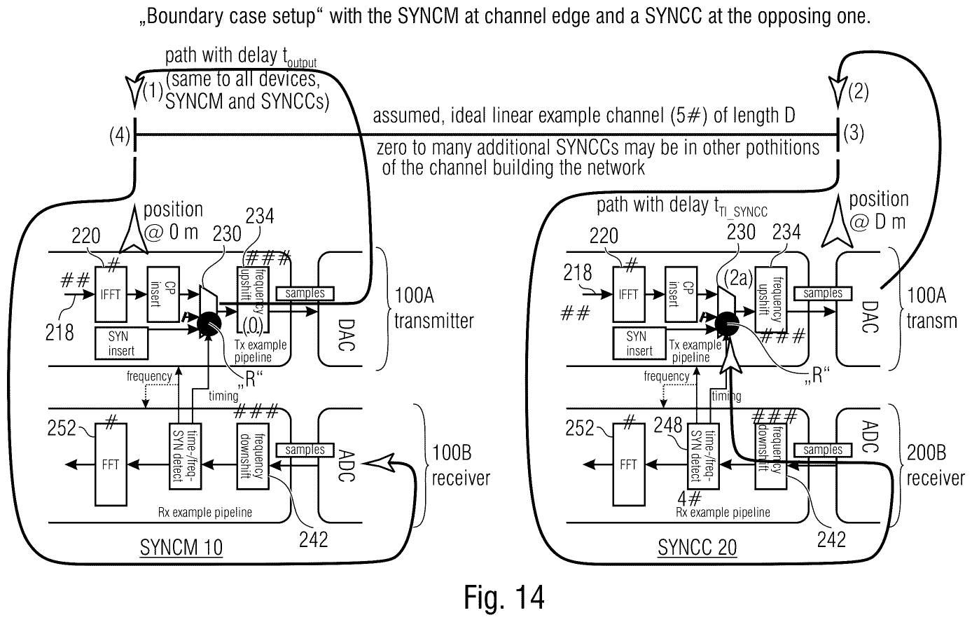

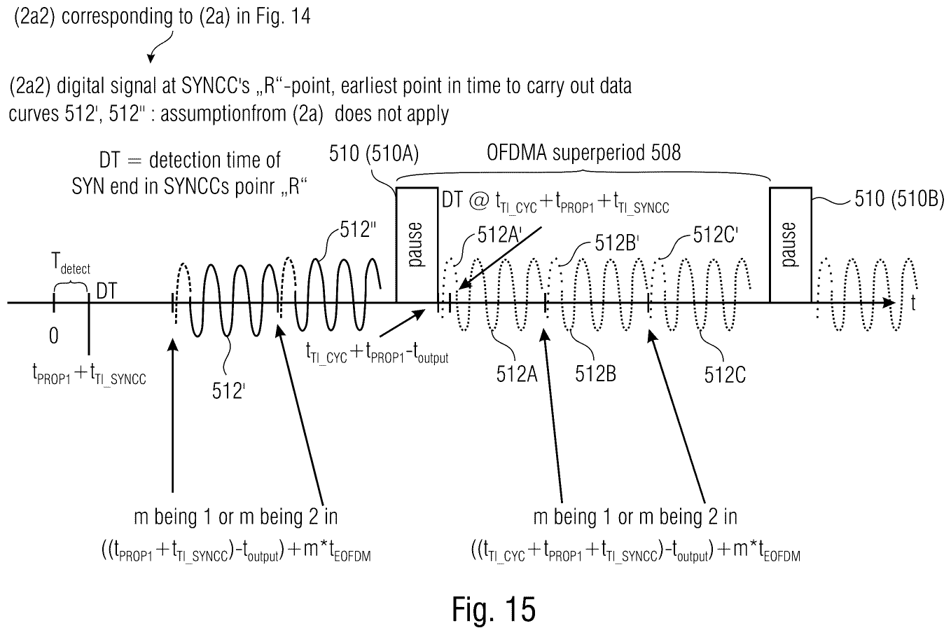

Beside a general OFDMA transmitter 200A and a general OFDMA receiver 200B, described in example above, a SYNCC 20 may implement the time and frequency synchronization detection block (248) at the receiver side 200B, providing a metric for timing detection by detecting the occurrence of the sequence 224 received from the master device 10. The time and frequency synchronization detection block 248 therefore provides information on the start of the next OFDMA symbol through path 249 by having e.g. a fixed offset (that also might be 0) to the next occurrence of an OFDMA symbol start on the channel at the client device location. When the transmitter 200A was frequency synchronized before (either by the techniques discussed here or by another technique), this provides time synchronization by enabling time correct release of the next OFDMA symbol part generated in the transmitter 200A (see “reference point R” in the description below and FIG. 14 “R”).

Another aspect with regard to the present examples is the choice of guard interval length (cyclic extension of the OFDMA symbol, that may be a cyclic prefix or cyclic postfix) in block 226 (cyclic prefix or postfix inserter) for all devices (both the master device 10 when implementing a transmitter and the client devices 20). The preferred minimum choice for the time length of the CP is mentioned in the further description. According to the OFDMA technique, generally there is also device assigned time and frequency resources. This assignment (which may be performed by a scheduler, which may be one device chosen among the SYNCC devices 20 and the master device 10) needs to be regarded too, but generally is out-of-scope of this invention.

When any kind of frequency offset synchronization is not provided in another way for the SNYCC device 20, the time and frequency synchronization detection block 248 also may provide one or more of the following metrics: timing offset metric (e.g., in the manner of: absolute timing of the current superperiod 508 minus absolute timing of the last superperiod 508 differs from awaited length of superperiod 508 or aggregate of this), sampling frequency offset detection (SFO) metric, carrier frequency offset (CFO) metrics. It is passed through path 251 (FIGS. 3B, 3E, 4A) to compensate for the offset directly and/or to compensate for dependent frequency offsets (e.g. STO is detected hinting to i) SFO one can and should compensate for. ii) Further, it might be an implementation sharing the same carrier and sampling clock reference and it ca be compensated for CFO too).

The SYNCM device 10, when also implementing the data path (like in FIGS. 3B and 3C, also referred as data communication enabled SYNCM), provides timing and frequencies for the whole system by implementing block 222 (synchronization signal insertion block, synchronization signal generation block). Thus, a SYNCM device 10 does not need to implement the path 249 and 251. A SYNCC 20 may therefore not have the information from block 222 (synchronization signal insertion block, synchronization signal generation block). The SYNCC 20 may therefore cyclically insert a pause, depicted by path 224′ in FIGS. 3a, 4a, 4b, outputting 0 while the SYN data occurs locally on the channel.

It is also possible (and in some cases even recommended) to reuse the timing metrics information from block 248 (in case of a SYNCC) or exclusively use it in (in case of a data communication enabled SYNCM) for the local data reception in the receiver side 200B or 100B, respectively. The timing information is forwarded through path 250 beside the time domain data forwarded to inform the FFT block (252) about the FFT decoding window 530 (see below) for data reception. The SYN 224, 510 itself might be forwarded or not through the path 250. cyclic prefix time length or cyclic postfix time length is known at the FFT block 252 and thus all timing data necessary for decoding is present at block 252. Path 251′ may thereby provide the metric or metrics for the receiver example processing chain, if not sharing the frequency or frequency reference with the local transmitter (despite the fact it is preferable the frequency or frequency reference is shared) or for compensating for residual frequency offset values in the example implementation if wanted and necessary.

FIGS. 3A, 3B, 4A, 4B show a full feature device, that can either act as a data communication enabled SYNCM 10 or as a SYNCC 20. The operational mode can be chosen by configuration. It is foreseen that the communication system contains exactly one SYNCM 10 and a plurality of SYNCC devices 20 at a time.

The SYNCM role either can be constant during runtime, or can be handed over either to a SYNCM/SYNCC reconfigurable device formerly configured as SYNCC or to a spare SYNCM device, formerly just listened to the channel for synchronization. Besides the mandatory components for implementing the SYNCM, the SYNCM/SYNCC reconfigurable device should also implement the path 240 to 249 and additionally to 251 (if frequency synchronization is also performed as below).

FIGS. 3A, 3B, 4A, 4B show the communication device 10 or 20 for OFDMA communication [e.g. multipoint-to-multipoint], configured to receive and transmit OFDMA signals (e.g. in OFDMA symbols). The communication device 10 or 20 may be configured to perform communications with other communication devices.

The client device (SYNCC) 20 offers this function of communicating, while a master device (SYNCM) 10 may be either used only for synchronization purposes (minimum SYNCM implementation, see FIG. 3C) or for communication and synchronization purposes (see FIGS. 3A, 3B, 4A, 4B, 3D (just data transmission or just transmitter side depicted), and description above: “data communication enabled SYNCM”), so that all the SYNCCs 20 synchronize to the timing of the master device 10, while a data communication enabled SYNCM can inherently run synchronous due to the possibility to reuse the local transmitter clocks, that define the network clocks. In some examples, the client device (SYNCC) 20 and the master device (SYNCM) 10 may be identical devices in which only their function in a network of devices change. For example, each device in the network may operate according to a mode selected between the master device mode (in which it operates as the master device 10) and a client mode (in which it doesn't operated like the master device 10, but operates as a communication only device 20). In FIGS. 3A, 3B, 4A, 4B, the SYNCC 20 is a device operating in SYNCC mode but could be, in principle, be selected to operate in master device mode. For example, in the client mode the communication device 20 of FIGS. 3A, 3B, 4A, 4B, does not use the SYN insert block 222 (but inserts the cyclical pause 224′ which is meant at being synchronous to the transmission of the SYN 510). In the following, it will be considered that FIGS. 3A, 3B, 4A, 4B are explicative of both the master device (SYNCM) 10 and the client device (SYNCC) 20. In theory, however, it is possible that the master device 10 and the client device 20 differ greatly from each other (see for example FIGS. 3C-3E). Each device 10 and 20 is considered to have (in particular in a physical medium dependent, PMD, which parameters may be optimized to the usage of the particular physical medium and executes signal modulation and demodulation) a transmitter side (100A in the master device 10 and 200A in the client device 20) processing bitstream data 202 provided from a Tx higher layer or sublayer (that is called Tx physical coding sublayer (PCS) and physical medium attachment sublayer (PMA) 201). In general case, there can be more than one bitstream 202, that is independently provided to be independently decodable at the remote Rx counterpart of one or a plurality of devices 20 or 10, integrated into one data stream processing inside the Tx PMD (201A) by the first internal processing step. For simplicity of the example, FIGS. 3A, 3B, 4B just show one bitstream, also assumed for the further description, representing one valid implementation. After processed by the Tx PMD, it is provided to the digital to analog (DAC) unit 238 (inputted by Tx samples 236). The receiver side (100B in the master device 10 and 200B in the communication device 20) processes data from obtained from the communication channel by the analog to digital (ADC) unit 240 (outputting Rx samples 242) in the Rx PMD sublayer to a higher layer or sublayer Rx processing that is called Rx PCS and PMA sublayer 266 in the further description (inputted with one or more received bitstreams 264). Further, in the subsequent passages, it is often considered that there is a plurality of client devices 20 in communication with each other, and synchronized by one single master device 10, that does not necessarily need to take part in data communication between the different devices (apart from the synchronization).

It will be noted that, in some advantageous examples, the signals transmitted (e.g., from the DAC 236 of a device 10 or 20 to the ADCs 240 of the other devices 10 or 20) may be wired signals (e.g., transmitted through electric signals e.g. in a wire, or optical signals e.g. in an optical fiber). The topology may be, for example, a bus topology. In other examples, however, the signals transmitted (e.g., from the DAC 236 of a device 10 or 20 to the ADCs 240 of the other devices 10 or 20) may be wireless signals (e.g., radio frequency signals or visible optical communication signals). Here, even if there is more noise than in the wired signals case, there is not the necessity of the wires.

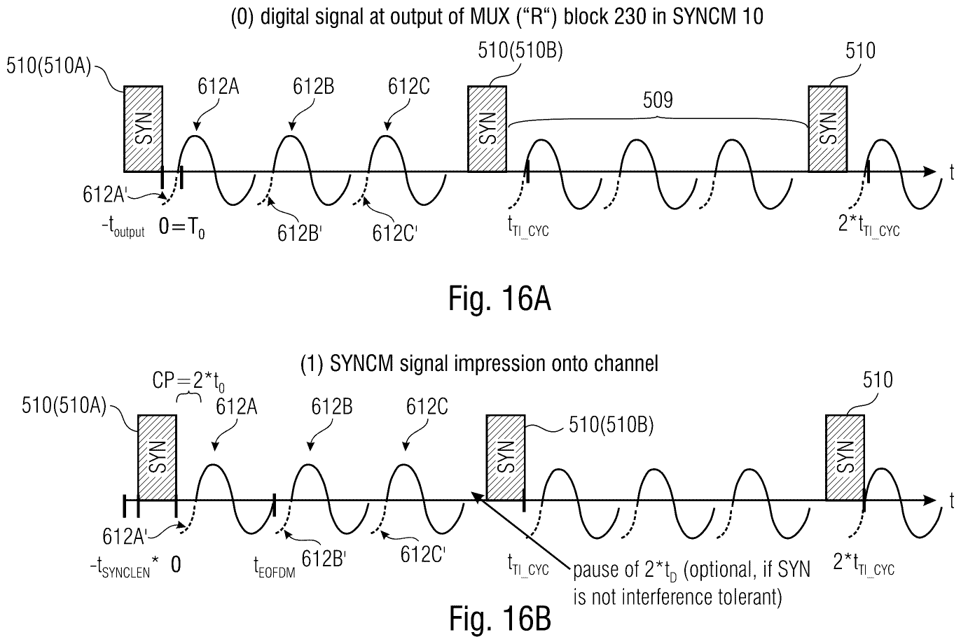

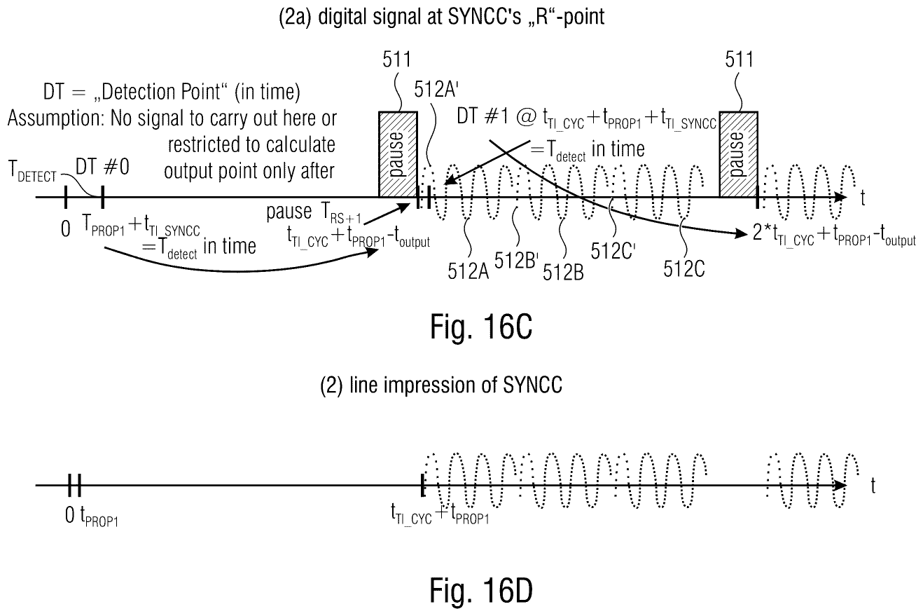

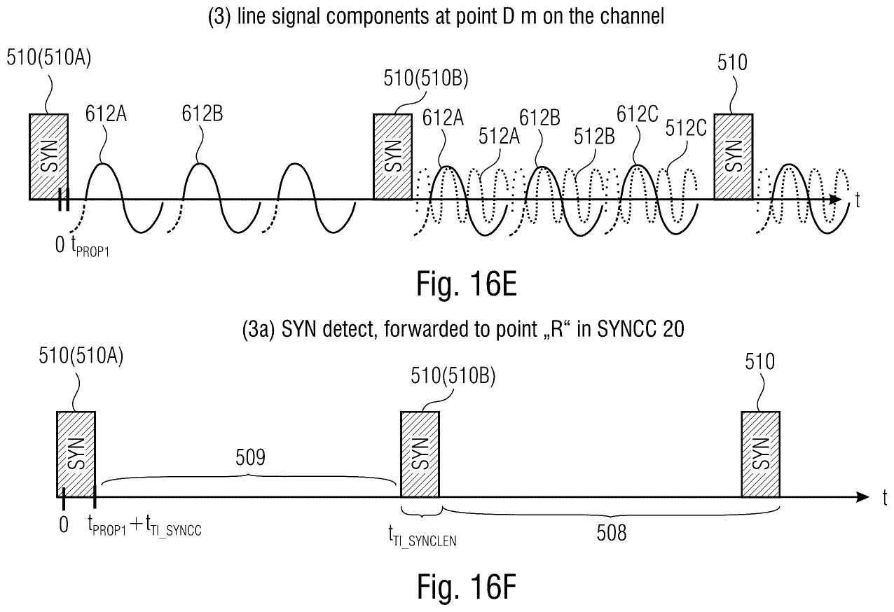

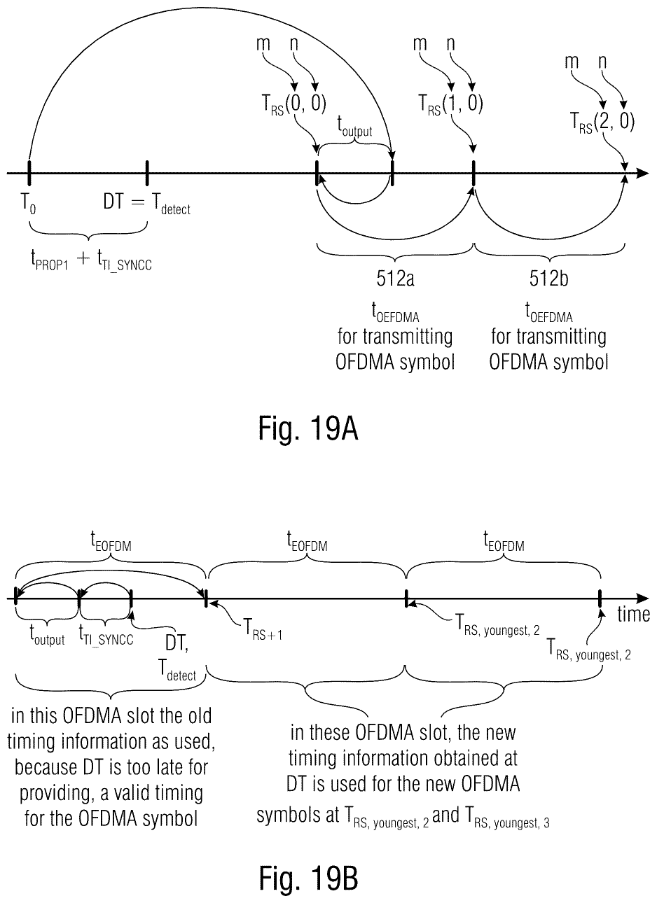

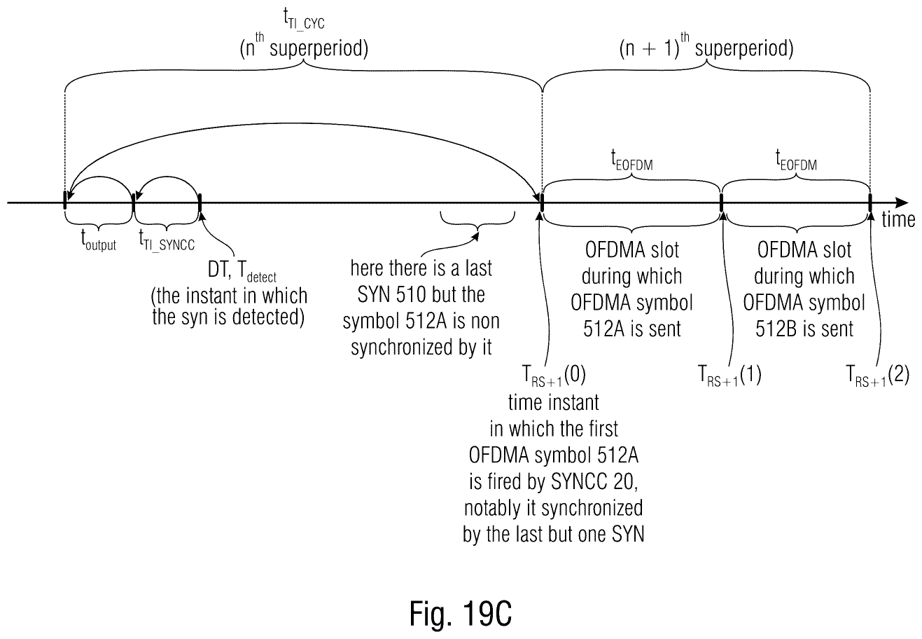

FIGS. 16A-16G show the signals generated in the master device 10 and the client device 20 in the scenario of a full frequency band SYN sequence (annotations to partial band SYN sequences can be found textual below), a periodical occurrence of 3 OFDMA symbols in between the periodically occurring SYN 510 (e.g. the first being 510A, the second 510B, etc.) and the master device 10 and the example client device 20 at opposing channel positions leading to the maximum signal propagation time allowed. The positions 0, 1, 2a (same as 2a2 and 3a), 2, 3 and 4 in the devices 10 and 20 are indicated in FIG. 14. FIG. 15 shows a scenario (alternative to that of FIG. 16C) where the calculation for the second and the third OFDMA symbol insertion to the channel by the client device 20 is based on the below-discussed formula “T_{RSyoungest}(m)=T_{detect}−(tₒᵤₜₚᵤₜ+t_{TI_SYNCC})+(m*t_{EOFDM})” (which also corresponds to the scenario of FIG. 19B). The scenario of FIG. 15 is alternative to the scenario of FIG. 16C and is based on the below-discussed formula “T_{RSyoungest}=T_{detect}−(tₒᵤₜₚᵤₜ+t_{TI_SYNCC})+(m*t_{EOFDM})” (which also corresponds to the scenario of FIG. 19C). The first occurrence thereby is calculated like in the FIG. 16C without further markups. The time axis utilized is global to FIGS. 15 and 16A-16G. The scenario displayed assumes the client device 20 was unsynchronized before and can and should to fire data as soon as it became fully synchronized. This happens based on the first SYN 510 (510A) displayed. In particular, the FIGS. 15 and 16A-16G show the positions:

FIG. 16A: position (0), i.e. at “point R” (block 230) of the master device 10 (i.e. the position at which block 230 triggers the firing of the SYN 510). This happens at the absolute time −(tₒᵤₜₚᵤₜ+t_{SYNCLEX}) for the first SYN 510 (indicated with 510A) displayed. It may be followed up by firing own OFDMA symbols (therefore it is a data communication enabled SYNCM) starting from the time −tₒᵤₜₚᵤₜ, depicted by signals indicated with 612A-612C, for ease of the example constant in every OFDMA symbol of every cycle and just containing one subcarrier. The cyclic prefix portion 612A′, 612B′, 612C′ of the OFDMA symbol 612A, 612B, 612C is depicted by the dotted lines, where the CP length can be chosen by exactly 2 times the maximum propagation delay, i.e. 2*t_{D} (thus CP portions 612A′, 612B′, 612C′ of the OFDMA signals 612A, 612B, 612C chosen for other reasons but support the proposed synchronization technique described that might be e.g. channel dispersion or inexact synchronization detection methods under certain circumstances is 0 and the CP 612A′, 612B′, 612C′ is extended then from 0 to 2*t_{D}) to finally support the aspects shown in FIG. 16F. The cycle repeats every t_{TI_CYC}, superperiod 508). Before the first SYN 510 (510A) displayed occurs, no data was sent in this example;

For the following descriptions, instants in time are not completely described, since they are calculable by the formulas and descriptions introduced below.

FIG. 16B: position (1) in FIG. 14, i.e. at the output to the channel of the master device 10. The signals 612A-612C from FIG. 16A occur delayed by the system (runtime, configuration or implemented) constant time tₒᵤₜₚᵤₜ. The absolute point 0 of the time axes are set to when the first SYN 510 (510A) displayed finished in this figure;

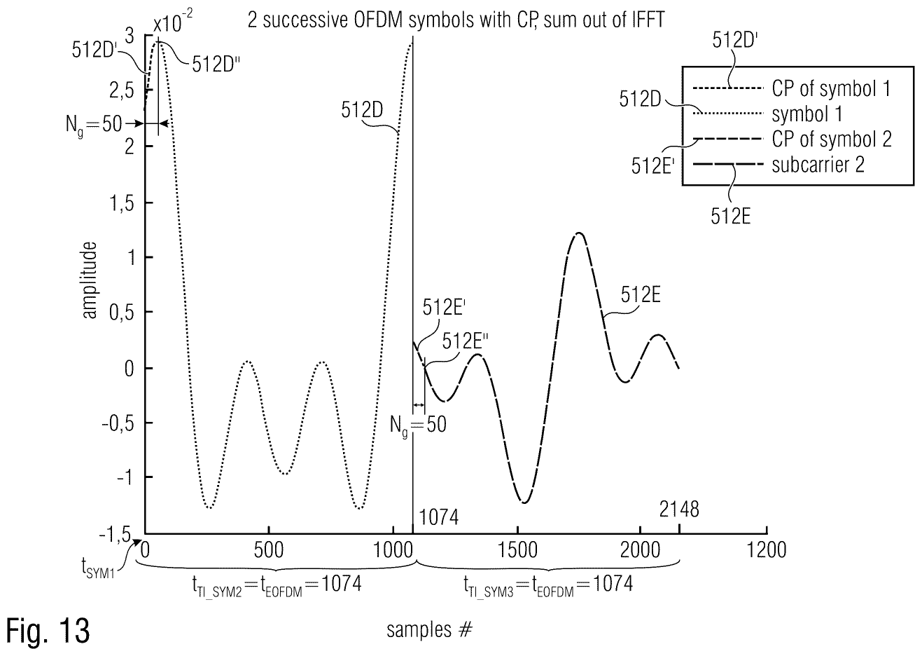

FIG. 16C: position (2a), i.e. at “point R” of the client device 20 (i.e., the position and the time instant at which block 230 triggers the firing of the OFDMA signal 512A-512C). For ease the example the OFDMA signal 512A-512C of the client device 20 is shown as containing just data on one subcarrier, displayed by the sine wave, that is represented as constant in all OFDMA symbols 512A-512C and subperiods in the figure and by design rule of same length as the OFDMA symbol portions from the master device (CPs are represented as 512A′, 512B′, 512C′, and they may correspond to CPs 512D′ and 512E′ of FIG. 13);

FIG. 15: The same position (2a) in FIG. 14 as in FIG. 16C for the alternative scenario described above.

FIG. 16D: position (2) in FIG. 14, i.e. at the output of the client device 20 (i.e., with respect to the instants depicted by FIG. 16C, it is impaired by the fixed processing delay Tₒᵤₚᵤₜ);

FIG. 16E: position (3) in FIG. 14 which is the same of position (2) but keeps into account the OFDMA signals 612A-612C received from the master device 10

FIG. 16F: displays the same position (2a) as FIG. 16C, but shows the SYN occurrence detection at the control input of block 230 to point out that arrival of the SYN 510 on the line, depicted in FIG. 16E has an offset of t_{TI_SYNCC} and therefore is not instantly taken into account due to processing delay and propagation delay inside the SYNCC. The full SYN depiction is virtual and should help in understanding the aforementioned aspect. Just the information of having detected the end of the SYN 510 and forwarded this information to “R” is present by the end of the depicted SYN 510. Further, the figure is utilized to depict the intervals 508, 509 and 510.

FIG. 16G: position (4), at the input of the master device 10 (with respect to FIG. 16E, the signal 512A-512C is delayed of the propagation delay). It depicts that a valid decoding window 530 of the needed length can be found (depicted by the square 530). Any other window 530 placed cannot decode the signal of the OFDMA symbol marked up by the window 530 without errors, since it will include signal portions from neighboring OFDMA symbols and thus lead to inter-symbol-interference.

Further characterization of FIGS. 14 and 16A-16G is provided below (section “Further characterization of FIGS. 14 and 16A-16G”).

It is noted that FIGS. 15 and 16A-16E are in the boundary case in which the distance between the master device 10 and the client device 20 is maximum.

It is noted that:
1) Despite the fact that for the scenario in FIG. 16C the system is instructed to always use the SYN 510 from prior superperiod 508, following is stated: As shown by FIG. 16C, the detection DT #1@T_{ti_cyc}+t_{PROP}+T_{ti_syncc} occurs while the client device 20 is sending the OFDMA symbol 512A, and therefore the OFDMA symbol 512A is synchronized not on the immediately preceding SYN 510 (510B), but on penultimate received SYN 510 (510A) (this may be common to the first OFDMA symbols in the sequence of the OFDMA subperiod 509)
2) Despite the fact that for the scenario in FIG. 16C the system is instructed to always use the SYN 510 from prior superperiod 508, following is stated: As shown by FIG. 16C, the client device 20 shall wait for a pause (with time length by counting for a time length t_{TI_SYNCLEN} synchronized to the penultimate SYN 510 (510A) received
3) The time length of the CP (or cyclic postfix) (either 512A′, 512B′, 512C′ for the client device or 612A′, 612B′, 612C′ for the master device) may be 2*t_{d}, i.e. the maximum propagation delay admitted for the system (based on the maximum distance admitted between two different devices)
4) FIGS. 16A-16G and 15 refer to the boundary case of the maximum distance between the master device 10 and the client device 20, but the window 530 will in any case find a correct version of the OFDMA symbol, because of the presence of the CP (of cyclic postfix)
5) As shown by FIG. 16C, as soon as the pause 511 (e.g. as counted by the counter) is finished, the client device 20 may start to trigger the transmission of the first OFDMA symbol 512A, starting from the CP 512A′.

The communication between the devices (client devices 20 and master device 10) is periodical (cyclical) according to a superperiod 508 (FIG. 15, “OFDMA superperiod”, and FIG. 16F) transmitted by the master device 10 at regular intervals. The time length occupied by the superperiod 508 is here indicated with t_{TI_CYC}. The superperiod 508 may be defined, for example, by consecutive synchronization signals 510 (SYNs) periodically transmitted by the master device 10 (see FIGS. 15 and 16Aff.), during which the client devices 20 (under the effect of 224′ in FIGS. 3B, 4A, 4B) do not transmit any signal inside the frequency band reserved for SYN, but only receive the synchronization signal 510 sent by the master device 10.

The synchronization signal 510 may occupy a time slot with time length indicated with t_{TI_SYNCLEN} (see FIG. 16F).

As explained above, the client device 20 may derive a transmission characteristic [e.g. timing, carrier frequency, sample clock, or combination thereof] on the basis of the received synchronization signal 510, and may adapt a subsequent transmission [from the client device 20 itself, to another device 10 or 20] to the derived transmission characteristic. In particular, the synchronization signal 510 may provide (e.g. at blocks 248 of the client device 20 to block 230 and/or block 248EV of the client device 20) synchronization information (249, 251) e.g. on timing, carrier frequency, and/or sample clock. The transmission characteristic may comprise subcarrier frequency [and/or subcarrier frequency offset] and/or carrier frequency [and/or carrier frequency offset]. From the synchronization information, the client device 20 may use the transmission characteristic for resynchronizing its internal clock (e.g. from block 248 to block 230 or 248EV).

The synchronization signal 510 is in general a periodic signal [a signal with a fixed time distance t_{TI_CYC} from the immediately preceding and/or immediately subsequent OFDMA symbol superperiod]. Between two subsequent periodic synchronization signals 510, a plurality of OFDMA symbol subperiods (e.g. slots) may be defined, each OFDMA symbol subperiod (slot) having the time length necessary for permitting one single OFDMA symbol to propagate. The OFDMA symbols transmitted by the client devices 20 are indicated with 512A, 512B, 512C in FIG. 16E. Notably, the master device 10 may also transmit OFDMA symbols (e.g. simultaneously to the transmissions of the OFDMA symbols 512A, 512B, 512C, in the OFDMA symbol subperiod) 612A, 612B, 612C (see FIGS. 16A and 16E) (e.g., the OFDMA symbol 612A from the master device 10 may be superposed to the OFDMA symbol 512A from the client device 20; the OFDMA symbol 612B from the master device 10 may be superposed to the OFDMA symbol 512B from the client device 20; and so on). The first OFDMA symbol 512A (and, in case, the first OFDMA symbol 612A from the master device 10) takes a time slot t_{TI_SYM1} with time length t_{EOFDM}, the second OFDMA symbol 512B takes a time slot t_{TI_SYM2} with time length t_{EOFDM}, etc., where the time length of all the OFDMA symbols is normally intended to be the same (however, it may in principle be possible that different OFDMA are defined have different time lengths is different OFDMA slots; in any case, the knowledge of the time is intended to be the same for generating OFDMA symbols with different time lengths). At the transmitter side 200A (100A), information to be transmitted from the client device 20 (or from the master device 10) to another device 10 or 20 is encoded in OFDMA symbols. FIGS. 3A, 3B, 4B show that a bitstream 202 is processed, through versions 206, 210, 218, towards OFDMA symbols 221 (e.g. generated by an IFFT block 220). At the receiver side 200B, the same information will be decoded from OFDMA symbols 250 (or in their predecessor versions 242, 246) onto bits forming a bitstream 264 (or their intermediate versions 254, 258, 262).

In the client device 20, after the reception of the synchronization signal 510 (e.g. in a synchronization subperiod), there can start an OFDMA subperiod 509 (taking a time length formed by the time length t_{TI_CYC} of the OFDMA superperiod 508 minus the time length t_{TI_SYNCLEN} of the synchronization signal 510; see also FIG. 16F), during which the client device 20 (e.g. together with other client devices 20), transmits transmissions and receives transmissions, from the master communication device 10 and/or from any other client device 20. The transmissions, both in transmission and in reception, result synchronized to the transmission characteristic derived from the synchronization signal 510.

The client device 20 may generate the transmissions as including a sequence of OFDMA symbols [e.g. the sequence of OFDMA symbols occupying the foreseen time slots (called OFDMA symbol slots or OFDMA slots) inside the OFDMA subperiod 509] based on synchronization reached from the synchronization signal 510 (e.g. from the immediately preceding synchronization signal 510, or e.g. a signal 510 that was received before, advantageously the youngest one that is possible and practical to process in the concrete implementation, due to information ageing). The client device 20 may generate one or both of:
for each OFDMA symbol of the sequence of OFDMA symbols, an initial cyclic extension (e.g. cyclic prefix, CP) in which there are copied the last samples of the OFDMA symbol;
for each OFDMA symbol of the sequence of OFDMA symbols, a final cyclic extension in which there are copied the first samples of the OFDMA symbol.

For example, FIG. 13 shows:
a first OFDMA signal 512D (which could be any of 512A and 512B) having an initial cyclic extension 512D′, and occupying the time slot t_{EOFDM}=1074 samples (of which N_{g}=50 samples are occupied by the initial cyclic extension 512D′ in the first guard time); and
an immediately subsequent second OFDMA signal 512E (which could be any of 512B and 512C) having an initial cyclic extension 512E′, and occupying the time slot t_{TI_SYM2}=1074 samples (of which N_{g}=50 samples are occupied by the initial cyclic extension 512E′ in the second guard time).

The synchronization signal 510 may be constructed to have a known sequence of OFDMA symbols (or more in general of samples), so that the client device 20 may obtain the transmission characteristic [e.g. timing, frequency, carrier, sample clock] on the basis of the received known sequence of OFDMA symbols].

It will be shown that the cyclic prefix and/or postfix may permit to tolerate indeterminate propagation delays due to indeterminate distances between the devices.

In time-frequency synchronization block 248 the transmission characteristic (e.g., frequency and/or time) can be determined and/or updated.

For example, from the received samples (and by virtue of the knowledge of the sequence of the synchronization signal 510), the client device 20 may determine (e.g. at block 248) the sampling rate (which may be the transmission characteristic or a component of the transmission characteristic).

For example, the client device 20 may (e.g. at time-frequency synchronization block 248) evaluate the difference between the current sample frequency (e.g. baseband frequency) and the frequency as determined from the synchronization signal, to thereby adapt the sample frequency by adopting a new sampling frequency compensating for the difference between the current frequency and the frequency as determined from the synchronization signal.

For example:
if the shape of the known OFDMA symbols constituting the synchronization signal 510 appears, in the time domain, too narrow (indicative of that the corresponding clock of the client device 20 is too slow in respect of the corresponding clock of the master device 10), then the communication device 20 (e.g. at block 230 or block 248EV based on the information of block 248) may increase the time length of each sample in transmission, so as to adapt the time length of the OFDMA symbols 512A-512C to the time length of the master device 10; and/or
if the shape of the known OFDMA symbols constituting the synchronization signal 510 appears, in the time domain, too large (indicative of that the corresponding clock of the communication device 20 is too fast in respect of the corresponding clock of the master device 10), then the communication device 20 (e.g. block 230 or block 248EV based on the information of block 248) may reduce the time length of each sample in transmission, so as to adapt the time length of the OFDMA symbols 512A-512C to the time length of the master device 10.

In practice, the sampling rate may be recalibrated based on the sampling rate of the received synchronization signal 510. This should not exclude other approaches.

In addition or in alternative, the synchronization signal 510 may comprise at least one carrier or subcarrier [e.g. according to a known sequence of carriers of subcarriers, in case of multiple carriers of subcarriers]. In this case, the client device 20 (e.g. block 248) may determine the transmission characteristic [e.g. timing, frequency, sample clock] on the basis of the received at least one carrier or subcarrier [e.g. the known sequence of carriers of subcarriers, in case of multiple carriers of subcarriers]. Hence, the client device 20 (e.g. through blocks 248 and 230 or 248EV) may adapt its transmission of the OFDMA symbols (512A-512C) to the derived frequency or frequency offset of the received carrier or subcarrier(s). As shown in FIGS. 3A, 3B, 4A, 4B, different carriers (210) and subcarriers are (when seen as Fourier transforms) different spectral values, from which it is possible to determine the frequency of the carriers and subcarriers. Therefore:
if the communication device 20 (e.g. block 248) determines that a carrier or subcarrier has a frequency higher than the expected frequency (indicative of the clock of the communication device 20 being slower than the clock of the masters device 10), then the communication device 20 (e.g. block 248) may force the subsequent OFDMA symbols 512A-512C to be based on a higher frequency (e.g., through blocks 230 or 248EV); and/or
if the communication device 20 (e.g. block 248) determines that a carrier or subcarrier has a frequency lower than the expected frequency (indicative of the corresponding clock of the communication device 20 being faster than the clock of the masters device 10), then the communication device 20 (e.g. block 248) may force the subsequent OFDMA symbols 512A-512C to be based on a lower frequency (e.g., through blocks 230 or 248EV).

In practice, the clocks from which the symbols 512A-512C may be calibrated on the received subcarriers from the synchronization signal 510. In addition or in alternative, it is possible for the communication device 20 (e.g. at block 248) to derive time difference (offset) information between the reception of symbols of the sequence of symbols and the assumed time of reception of the symbols of the sequence of symbols. Hence, the communication device 20 (e.g. block 248) may derive the transmission characteristic [e.g. timing, frequency, sample clock] from the time difference information].

For example:
if the client device 20 determines (e.g. at block 248) that a the synchronization signal 510 arrives too early (indicative that the clock of the client device 20 is too slow in respect to the clock of the master device 10), then the client device 20 (e.g. through blocks 230 or 248EV) may increase the clock rate for the subsequent OFDMA transmissions and/or
if the client device 20 determines (e.g. at block 248) that a the synchronization signal 510 arrives too late (indicative that the clock of the client device 20 is too fast in respect to the clock of the master device 10), then the client device 20 (e.g. through blocks 230 or 248EV) may decrease the clock rate for the subsequent OFDMA transmission.

Summarizing, the client device 20 (e.g. block 248) may derive a transmission characteristic (sampling rate, time offset, frequency) based on the received synchronization signal 510, and may adapt the transmission characteristic (sampling rate, time offset, carrier frequency) to the received synchronization signal 510.

Despite the examples above, the transmission characteristic may include more than one metric (e.g., both the sampling rate and the time offset, or both the frequency and the time offset, or both the sampling rate and time offset and frequency). Basically, the transmission characteristic may be adapted in feedback from analysis of the synchronization signal 510.

In addition or in alternative, the transmission characteristic (e.g. first transmission characteristic) that is used to determine the synchronization (e.g. the metric used) may be different from the transmission characteristic (e.g. second transmission characteristic) which is controlled in feedback. For example, it may be that the sampling rate is determined, and based on the sampling rate the offset of the transmission of the OFDMA symbols 512A-512C is anticipated or delayed.

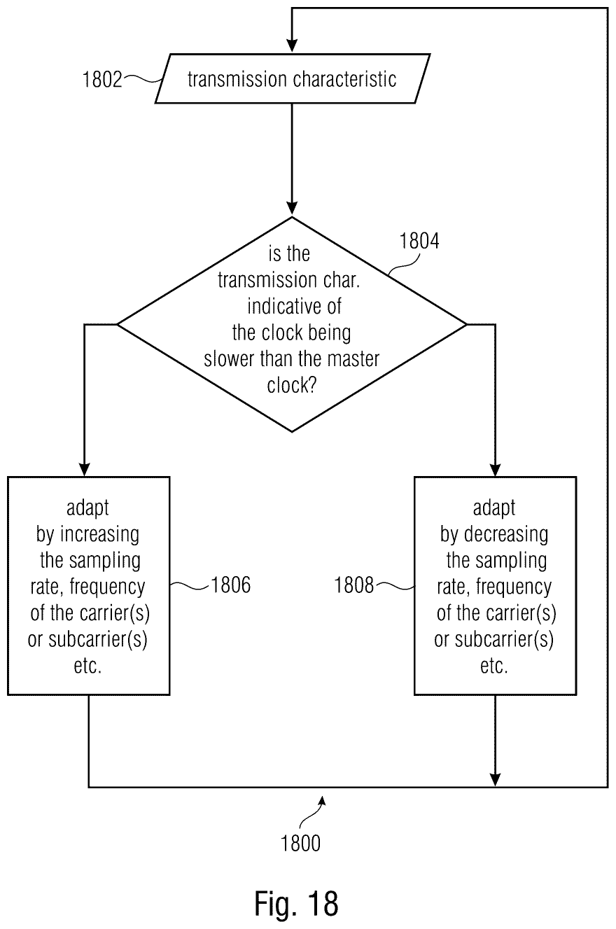

FIG. 18 shows an example 1800 of operation (e.g. of block 248). In step 1802, the transmission characteristic (e.g. metric) may be obtained (e.g., as an offset, a frequency, a sampling rate, etc.). The operation 1800 may permit to perform the operations of FIGS. 15-16F (the operation 1800 may perform frequency synchronization, FIGS. 15-16F may perform timing synchronization). In particular, operation 1800 may be carried out (in some examples) initially (step 2a) before the SYNCC in FIGS. 15-16F may operate this way (step 2b). The step 3 may also use it. In step 1804, it is evaluated whether the transmission characteristic is indicative of the clock of the client device 20 being faster or slower than the clock of the master device 10. Then:
in case it is determined that the clock of the client device 20 is slower than the clock of the master device 10, then in step 1806 the transmission characteristic is adapted, e.g. by increasing the sampling rate, anticipating the transmission of the OFDMA symbols 512A-512C, and/or increasing the frequency of the carrier and/or subcarrier(s); and/or
in case it is determined that the clock of the client device 20 is faster than the clock of the master device 10, then in step 1808 the transmission characteristic is adapted, e.g. by reducing the sampling rate, delaying the transmission of the OFDMA symbols 512A-512C, and/or reducing the frequency of the carrier and/or subcarrier(s).

Therefore, in the communication device 20 (e.g., in block 248):
1) The transmission characteristic (e.g. a first transmission characteristic) may be evaluated as any of (or any combination of):
a. Sampling rate
b. Frequency of the carrier
c. Frequency of the subcarrier(s)
d. Delay (offset) of reception of a part (e.g. one or more OFDMA symbol(s)) or of the whole synchronization signal 510
2) In case of
a. the transmission characteristic (first transmission characteristic) being determined as indicative of the clock of the communication device 20 being slower than the clock of the master device 10 (e.g., because of the received symbols (e.g. symbols of the synchronization signal 510 are received as being too narrow, and/or because the received subcarrier(s) or carrier are detected as having too high frequency, and/or because the offsets of the received symbols of the synchronization signal 510 are received earlier than expected), then the communication device 20 will control the transmission characteristic (second transmission characteristic) by:
i. increasing the sampling rate; or
ii. increasing the frequency of the carrier and/or subcarrier(s)
b. the transmission characteristic (first transmission characteristic) being determined as indicative of the clock of the communication device 20 being faster than the clock of the master device 10 (e.g., because of the received OFDMA symbols of the synchronization signal 510 are received as being too large, and/or because the received subcarrier(s) or carrier are detected as having too low frequency, and/or because the offsets of the received OFDMA symbols of the synchronization signal 510 are received later than expected), then the communication device 20 will control the transmission characteristic (second transmission characteristic) by:
i. reducing the sampling rate; or
ii. reducing the frequency of the carrier and/or subcarrier(s).

In the examples above, the evaluations may for example be performed though correlations of the received signals with pre-stored signals. A high correlation result may indicate that the received signal is similar to the expected signal. In general terms, a correlator in block 248 may provide an information on an early instant or a late instant in time against an awaited one from before (or aggregate, e.g. an average or an integral value).

In addition or in alternative, the client device 20 (e.g. in block 248) may evaluate the difference between a current frequency (e.g. timing frequency, symbol frequency, sample clock, sampling frequency) and a frequency (e.g. timing frequency, symbol frequency, sample clock, sampling frequency) of the synchronization signal, to thereby adapt the transmission frequency of a subsequent transmission from the client device 20. The client device 20 may adopt a new frequency which compensates for the difference between the current frequency and the frequency as determined from the synchronization signal [e.g. if the difference is positive, then the compensation will be negative, and if the difference is negative, then the compensation will be positive] [e.g. the larger the difference, the larger the compensation, and the smaller the difference, the smaller the compensation].

In addition or in alternative, the client device 20 (e.g. in block 248) may perform:
a first, rough synchronization, [e.g. based on the transmission characteristic e.g. based on the time difference between the assumed reception of a symbol of the synchronization signal 510 and the actual reception of the symbol of the synchronization signal 510], so as to derive a frequency offset, and compensate for a frequency offset, and/or
a second, fine synchronization, to derive the time instant to send an OFDMA symbol.

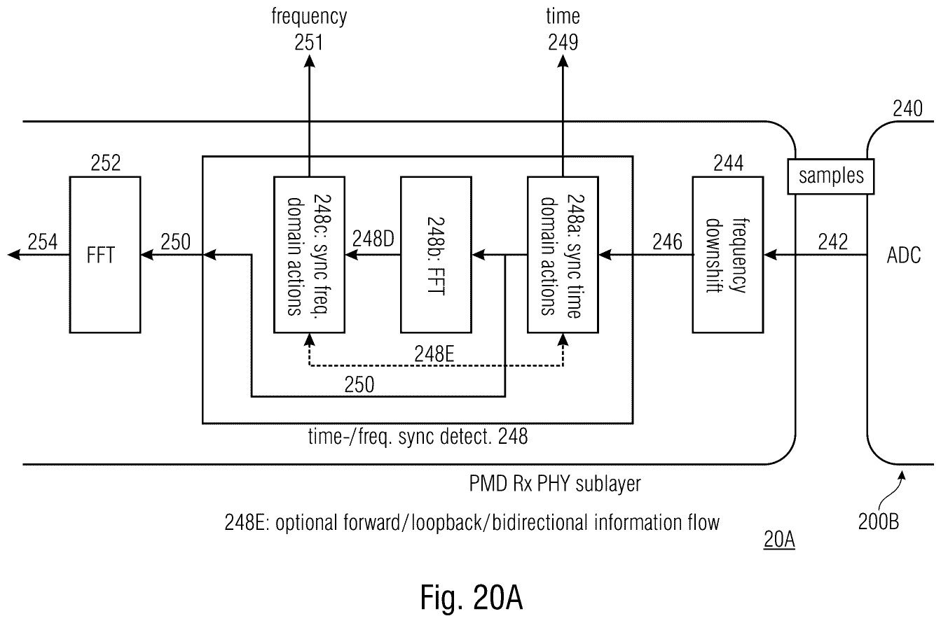

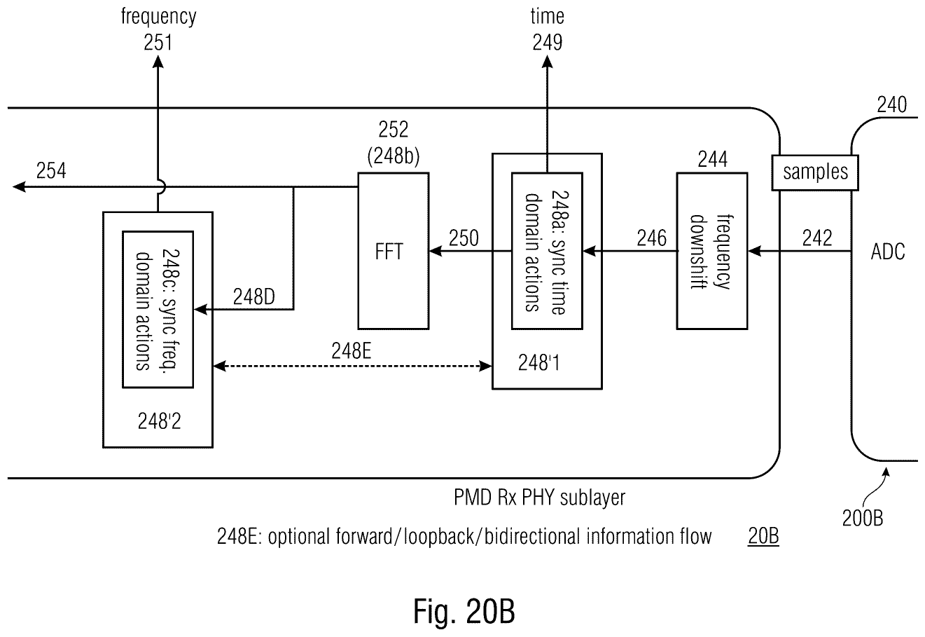

E.g., the “time and frequency synchronization detection” block 248 may perform some of the same actions the post 248 blocks of the data receiver perform, thus of blocks 252, 256, 260, 263, blocks beyond or blocks placed beside or in between this part of the processing chain. For efficiency reasons, the implementer of such receiver can decide to reuse these blocks (e.g. 252, 256, 260, 263) for synchronization detection, e.g. if the blocks (e.g. 252, 256, 260, 263) are currently free for the action. It might be fed from an unmodified data path or be switched for having other input data. This does not perform another action but a corresponding, fully equipped block 248 working as depicted in FIGS. 3A, 3B, 4A, 4B and as an example more detailed in FIG. 20A, which shows a particular of the received pipeline 200B of a variant 20A of the client device 20 of FIGS. 3A, 3B, 4A, 4B (it may be understood that the transmitter pipeline of the device 20A of FIG. 20A may be substantially the same of the transmitter pipeline 200B of any of FIGS. 3A, 3B, 4A, 4B). The variant 20A distributes its exclusive subfunctions into the remaining portions of the device to perform common or similar functions with the processing resources of the remaining transceiver in the upper scenario. FIG. 20A shows the variant 20A having a fully equipped exemplary sync function, that determines the time instant in which the SYNC 510 is received through block 248, based on received time domain data by the subblock 248a (which has, inter alia, the task of providing the timing information 249, to trigger the firing of the subsequent OFDMA symbols 512A etc.). Subblock 248a also forwards the other, non-synchronization data through path 250. Additionally, block 248 includes an FFT block 248b, exemplarity fed by the same data (250) as the remaining blocks of the device, and outputting frequency domain data 248D. Downstream to the FFT block 248b, frequency domain data 248D present might be the same as that in path 254 outputted by FFT block 252. The subblock 248c may perform actions on the frequency-domain data 248D to obtain a frequency metric to be forwarded to the local transmitter through path 251. There might be a data flow between the blocks 248a and 248c through 248E.

FIG. 20B shows an alternative variant 20B (which may substitute the variant 20A in any of the examples of FIGS. 3A, 3B, 4A, 4B). Here, the block 248 is divided between a first block 248′1 (processing time domain operations) and a second block 248′2 (processing frequency domain operations), wherein the FFT block 252 (248b) is interposed between the first block 248′1 and the second block 248′2. The pre-FFT actions (time domain actions) of block 248 may be extracted into the first block 248′1 and the post-FFT actions (frequency domain actions) into the second block 248′2, reusing the FFT block 250 for the actions the FFT block 248b performs (with respect to the variant 20A of FIGS. 20A, there is no modification of the FFT block 252 input data 250 and output data 254 needed or performed inside the subblocks 248a and 248c). Therefore, an advantage is attained in that the frequency information 251 is obtained by the variant 20B by performing only one singe FFT.

The above notwithstanding, however, it is possible to perform:
1) a first, rough synchronization (e.g. through the frequency information 251), to derive the frequency offset (and therefore to compensate it)
2) a second, finer synchronization (e.g. through the frequency information 251), to derive the time instant in which the OFDMA symbol is to be fired

It is possible for the client device 20 to perform ameliorations which permit to reach better transmission quality.

It will be shown that it is possible to synchronize the client devices 20 to the master device 10 so that propagation delay(s) (also indicated with T_{PROP1} and T_{PROP2} that are both equal to t_{d} in the boundary case example provided by FIGS. 14, 15, 16A-G) and internal processing delays (e.g. Tₒᵤₚᵤₜ, which is the processing delay in the transmitter side 200A of a client device 20 downstream to the signal version 227, and t_{TI_SYNCC} which is the delay of the receiver side 200B upstream to block 248) are kept into account.

At time DT (also indicated as T_{detect}) the detection of the SYN signal 510 is concluded at the client device 20. This means that the reference time T₀ (time after the master device 10 has fired the transmission, at point R, of the SYN signal 510 and the SYN signal 510 propagated to the channel through the master device 10 lasted tₒᵤₜₚᵤₜ) can be back determined as T₀=T_{detect}−T_{PROP1}−T_{TI_SYNCC} (more in general, the transmission characteristic is determined and the propagation delay from the master device 10 to the client device 20 and the delay of the receiver side 200B upstream to block 248 are kept into consideration). This timing will be used for transmit any subsequent ODFMA symbol (either in the same superperiod 508 or in the subsequent superperiod) before a new synchronization. The processing delay Tₒᵤₚᵤₜ after the signal version 227, as well as after the output of the SYN, common to both the master device 10 and the client device 20, is also taken into account (e.g., by anticipating the transmission of the OFDMA symbol by Tₒᵤₚᵤₜ), to be able to reduce the (increment in) temporal length of the cyclic extension to the rule 2*t_{D}, as described below. For example, there may be T_{RS}(m,n)=T₀+n*t_{TI_CYC}−tₒᵤₜₚᵤₜ+(m*t_{EOFDM}), where n is the particular superperiod (n=0 for the present superperiod), and m is the m-th OFDMA symbol of the superperiod.

In general terms, it may be understood that:
1) each client device 20 has, at a certain point R of the transmitter side 200A (e.g. point R, e.g. at block 230), at least one OFDMA symbol to be transmitted (action S)
2) however, this OFDMA symbol to be transmitted is sent by taking into account:
a. the timing information (transmission characteristic, e.g. time 249) from the master device 10
b. the processing delay Tₒᵤₚᵤₜ of the transmitter side 200A of the client device 20 downstream to the point R
c. the processing time of the receiver side 200B of the client device 20 upstream to the block 248 which receives and updates the transmission characteristic
d. whereas the propagation delays Tₚᵣₒₚ₁ and/or Tₚᵣₒₚ₂, that may not exceed t_{D} are implicitly taken into account by the temporal extension of the cyclic extension by 2*t_{D}.
3. A goal to be achieved

The present invention concerns a synchronization processing/synchronization approach for MP2MP-OFDMA systems.

It is one goal of the processing to enable the reception of distributedly created OFDMA symbols within a channel of a MP2MP system ideally without loss of orthogonality, however, at least with acceptable losses of orthogonality at any other point within the system channel. The processing allows to create orthogonal frequency portions of OFDMA symbols (to send sub-carrier data) at any location in the channel area and to decode them at any other channel location, provided that the corresponding sub-carrier has been allocated to the transmitter by a central entity at the corresponding point in time. Allocation to the transmitter may provide for reserved exclusive use of the subcarrier resource inside the OFDMA symbol slot, provided that no additional orthogonal or orthogonizable dimension participates in the multiple-access scheme the system equips, or provided that such dimension is regarded too. This allocation task may also be carried out by the SYNCM (master device) 10.

### Solution

The following may be a precondition for applying the processing:

For the part of the time synchronization described below it is advantageous (and in some cases even necessary) to define the channel in a spatially limited way if this is not already the case in a sufficiently implicit physical way (e.g. by signal attenuation or spatial expansion of a waveguide channel). The following considerations assume a natural or artificially limited maximum channel length of D meters (or another distance measurement unit) so that there is a maximum propagation time across the entire channel t_{D} of

$${t}_{D} = \frac{D}{{ε}_{r} \cdot {c}_{0}}$$

with the vacuum speed of light co and the relative permittivity of the channel medium εᵣ, which, in case of a mixed channel medium, is to be averaged according to the longest temporal signal propagation path to be expected.

### Processing Part 1: Information to be Transmitted on the Transmitter Side (Exclusive Auxiliary Information for Carrying Out the Processing or Using Appropriate Waveform Properties)

As shown by FIGS. 15, 16A-16C, and 16E-16G, the SYNCM 10 may transmit, regularly in temporally fixed intervals t_{TI_CYC} known (e.g. cyclically, periodically, e.g. with period t_{TI_CYC} defining the superperiod 508) to all participating communication devices 20, the SYN 510 (e.g. e.g. in a synchronization subperiod with time length t_{TI_SYNCLEN}) whose time of receipt is detectable for time synchronization by the client devices (SYNCCs) 20. The starting time of the interval of length t_{EOFDM} in which the SYNCM 10 allows to insert the next possible OFDMA symbol portion (OFDMA symbol slot) of the client device 20 and possibly transmits own OFDMA symbol contributions is known. If sampling frequency synchronization (e.g. through information 251) is to take place, when receiving the SYN 510 or a synchronization information additionally transmitted by the SYNCM 10, the difference between the sampling frequency of the SYNCM 10 and the current sampling frequency of the receiving nodes (synchronization client(s), SYNCC(s) 20) can be measured (e.g. by block 248). If carrier frequency synchronization is still to take place, when receiving the SYN 510 or a synchronization information additionally transmitted by the SYNCM 10, the difference between the carrier frequency of the SYNCM 10 and the current carrier frequency assumption of the SYNCCs 20 can be measured (e.g. by block 248). Until reaching synchronization for the first time, no SYNCCs 20 should transmit any signals into the orthogonal frequency band. All communication resources in the system that contain an exclusive synchronization information of the SYNCM 10 may be only occupied for this information by the SYNCM 10, provided that sufficiently subtracting out the simultaneous information of a SYNCC 20 cannot be ensured or their sufficient non-interference with the synchronization information is known.

By means of a structural design of communication devices 10 and 20, it is possible for the measurability of certain offsets to be carried out indirectly. For example, if the sampling frequency and the carrier frequency are derived from the same frequency reference, one offset can be inferred by measuring the other. This is considered to be corresponding information with respect to the above paragraph.

### Indication A:

To adhere sufficiently to all orthogonality conditions in the OFDMA system, a symbol timing offset (STO), a sampling frequency offset (SFO) and a carrier frequency offset (CFO) can be kept within sufficiently small boundaries at least after reception and prior to a final demodulation of the orthogonal carriers of an OFDM/A symbol.

### Indication B:

The system designer decides what is to be considered a sufficiently small offset (STO, SFO, CFO). The larger the range of acceptance of this offset is selected outside of the following boundaries, the more interference occurs due to loss of orthogonality.

For OFDM systems, [21] finds the following boundaries, starting from which, under the assumption of a fully interference-free channel, fully interference-free decoding is possible:
1) STO: [−N_{g};0], when measured in amount of samples ([21], equation 25,

$$[ \frac{{T}_{max}}{T} ] - {N}_{g} \leq {n}_{s} \leq 0$$

with T being the sampling duration of a single sample and τₘₐₓ being the maximum delay time of the latest signal component arriving; thus, T/τmax expresses the full delay spread of the signal measured in “amount of samples”. n_{ε} thereby defines the range of allowable timing offset measured in samples), wherein possible channel dispersion has to be additionally considered and decreases this range. N_{g} is the length of the guard interval known as “cyclic prefix” (CP). It is assumed that there is no SFO at the same time.
2) SFO:0 ([21], equations 37, 38, 39) (basically indicating that all but 0 becomes signal quality reduction, the larger the offset the more “noise” (interference modeled as noise), introduced by the relative amount of SFO ζ (equal to (“transmitter sample time”−“receiver sample time”)/“transmitter sample time”))

$${z}_{l , k} = ( {e}^{j {πϕ}_{k}} \cdot {e}^{j 2 π ( ( {lN}_{s} + {N}_{g} ) / N ) {ϕ}_{k}} ) \cdot si ( {πϕ}_{k} ) {a}_{l , k} {H}_{k} ( ICI ) + {\sum }_{i ; i \neq k} ( {e}^{j {πϕ}_{i , k}} \cdot {e}^{j 2 π ( ( {lN}_{s} + {N}_{g} ) / ( N ) {ϕ}_{i}} ) \cdot si ( {πϕ}_{i , k} ) {a}_{l , i} {H}_{i} + {n}_{l , k} \qquad ( 37 )$$

with cross-subcarrier and subcarrier local frequency offset parameters

$${ϕ}_{i , k} = ( 1 + ζ ) ( Δ {fT}_{u} + i ) - k {ϕ}_{k} = {ϕ}_{k , k} \approx Δ {fT}_{u} + ζ \cdot k \qquad ( 38 )$$

respectively. Again modeling the irreducible ICI as additional noise n_{Ω;l,k}, the demodulation signal becomes

$${z}_{l , k} = ( {e}^{j {πϕ}_{k}} \cdot {e}^{j 2 π ( ( {lN}_{s} + {N}_{g} ) / ( N ) {ϕ}_{k}} ) \cdot α ( {ϕ}_{k} ) {a}_{l , k} {H}_{k} + {n}_{Ω ; l , k} + {n}_{l , k} . \qquad ( 39 )$$

### (Source: [21])

If the boundaries described in the following are adhered to, there is no additional inference added by violating the STO condition stated under 1) by SFO. This also assumes freedom of channel dispersion, which has to be additionally included so as to be considered:

Assuming an age of an exact time synchronization to the original window (start of the CP-free original decoding window) of I past OFDM symbols and a relative SFO of ζ (with +Rx currently being faster than Tx, −Rx currently being slower than Tx), an OFDM symbol length including a guard interval, or CP, of N_{S}, the n-th decoded OFDM symbol sample (without CP) of the I-th symbol falls in the range (n+Ng+l NS) element from [l NS−ζl NS; (l+1)NS−ζ (l+1) NS]. ([21], Equation 36, ζ defined in [21] next to Equation 34)

Assuming an original STO of 0, what follows is that a right-side value range under currently occurring real relative SFO minus a right-side value range with an SFO of 0 with both boundaries after I OFDM/A symbols still fulfills the STO condition [−N_{g};0]. With STO introduced voluntarily, ζ may adopt both signs. With limited accuracy of the STO measurement method and with consideration of possible channel dispersion, this range decreases accordingly.
3) CFO: 0 ([21], equations 37, 38, 39, introduced by the absolute amount of carrier frequency offset Δf)

OFDMA systems behave similarly. However, what occurs here are signal source-individual offsets (STO, SFO, CFO) that are reflected in the sum elements of the equations. In this case, each source is to adhere to the corresponding offset conditions [in particular with respect to 1) and with respect to “sufficiently”].

### Indication C:

There are known measurement methods for timing, SFO, and CFO. Such methods, as well as new methods, may be used. For example, timing and SFO may be measured by means of [24] or [25], without being limited to this.

### Processing Part 2a: Initial Frequency Synchronization of the SYNCCs 20.

Prior to reaching sufficient time and frequency synchronization (by this method or a mixed method), SYNCCs 20 are not allowed to transmit signals to the channel.

If the corresponding frequency offset (SFO and/or CFO) has been measured (e.g. by block 248) by means of a suitable method, the individual transmission frequency is adjusted so as to compensate the same or a dependent one. This may be done, e.g. by block 248EV in FIG. 4B or 230 in FIG. 3E, which exemplarily stand for suitable methods, or exemplarily in words e.g. by general adjustment of the sampling and/or carrier frequency (transmission characteristic) of the entire OFDMA transmitter DSP pipeline (200A), by adjustment of a common reference frequency (common as to SFO and CFO and/or common as to the transmitter and receiver path of the SYNCCs 20) or by a corresponding post-processing and frequency adjustment at the end of the transmitter DSP pipeline (200A). The goal is to have a smallest possible SFO, CFO respectively, between SYNCM and SYNCCs, which ideally should be 0: all SYNCC transmission DSP pipelines 200A in the system then run frequency-synchronous (with respect to SFO and CFO) to the output of the SYNCM transmission DSP pipeline 100A, thus, all participating device transmitters output frequency-synchronous signals.

### Processing Part 2b: Time Synchronization of the SYNCCs 20

The timing measurement may be carried out on the basis of the corresponding synchronization information (e.g. 249) mentioned in part 1. As shown by FIGS. 16D and 16E, the time of receipt in a SYNCC 20, assuming the SYNCM position at an arbitrary location of the channel, a time span T_{PROP1} from the continuous value range ]0; t_{D}] has passed due to the signal propagation time. A further limitation of the value range is possible if the position of the SYNCM 10 in the channel is being limited (e.g. it might be restricted to be placed exactly in the middle of the channel and the range therefore limits to ]0; t_{D}/2).

Additionally, there are known latencies t_{TI_SYNCM} on the transmitter side 100A of the SYNCM 10 (by generating this information or by reading-out this information from a storage, by the following processing steps, by propagation delays in the SYNCM 10 itself), and there are known latencies t_{TI_SYNCC} on the receiver side 200B of the SYNCC 10 until having the information about the reception of this information (e.g. when the block 248 determines the transmission characteristic and has the knowledge of the timing) and the processing at the fixed reference point R (227) in the transmitter 200A (e.g. including preceding processing steps, propagation delays in the SYNCC 20, detection delays, transmission of the receipt of time synchronization information at the local receivers and processing of the receipt information there). Beyond the reference point R (230), e.g. in blocks 230, 234, 238, etc., there should only be dedicated, known processing latencies tₒᵤₜₚᵤₜ common to all devices 20 (and the device 10 in our example, check next bracket), as well as known device internal propagation delays common to all devices in our example (necessarily to all SYNCCs 20, due to the displayed architecture in FIG. 14 also to the SYNCM 10, that is no more important for the outcoming formulas below), which allow to infer the start of the output of a following OFDMA symbol Tₒᵤₜₚᵤₜ in the channel from the transmitter DSP processing chain if a common processing state S is reached at point R (e.g. with R being at 230, in correspondence of block 230, inputted through 227 by the “cyclic prefix generation unit” 226, S corresponding to the time of the first output sample of the cyclic prefix inserted by the cyclic prefix generation unit 226). Thus, t_{TI_SYNCM} may be understood as being equal to tₒᵤₜₚᵤₜ reduced by the time implied by the actions “generating or reading out synchronization information”. The OFDMA symbols which are outputted subsequently then all start with a known temporal offset with respect to Tₒᵤₜₚᵤₜ at the channel output of the device until a time synchronization information is output again (usually, but not strictly necessarily, periodically in fixed intervals lasting t_{EOFDM}, representing a fixed duration of the OFDMA symbols (slots), including the cyclic extension; this is assumed for the further description, without loss of generality).

An arbitrary signal of SYNCC transmitter 200A, i.e. also a portion of a distributedly created OFDMA signal portion, requires a time t_{PROP2} (see FIG. 16G) assumed to be not known in detail from the continuous value range ]0; t_{D}] for propagation in the channel.

The temporal length N_{g} of a guard interval specified across the system at a point in time, wherein said guard interval is to be filled with a cyclic repetition (e.g. 512D′ and 512E′ in FIG. 13) of the signal portions of an associated OFDMA signal (e.g. cyclic prefix) 512D, 512E (which may be 512A, 512B, 512C), is to be increased, in addition to the length selected for other reasons (e.g. multipath propagation between specific transmission devices and specific reception devices or uncertainty of the timing measurement method), by t_{PROP1_max}+t_{PROP2_max}, (wherein t_{PROP1_max} and t_{PROP2_max} are the maximum admitted propagation time from the master device 10 to the client device 20, and from the client device 20 to the master device 10, respectively) i.e. without further limitation of the position of the SYNCM 10 by 2*t_{D} (where t_{D})=t_{PROP1_max}=t_{PROP2_max}). The outcome of this is to find a valid decoding window 530 (FIG. 16G) for decoding an the OFDMA symbol (512A-512D) at any spatial point in the channel after timing synchronization (i.e. after having been adapted to the transmission characteristic).

The time synchronization may be achieved by distributed communicating SYNCC transmitters 200A performing, at the reference point R (230), the transmitter DSP chain 200A that they have in common with the SYNCM 10, the processing step S also simultaneously carried out at point R in the SYNCM 10. A back-calculation of an allowed starting time of transmission for SYNCCs 20 by the output of the SYNCM 10 at the processing point R (230) already carried out independently does not always have practical relevance, due to the cyclic occurrence of the synchronization information, the correct timing for the output may be calculated in advance after the next synchronization information located on the channel.

For the further description, the temporal length t_{TI_SYNCLEN} (synchronization subperiod) of the synchronization signal 510 is introduced. FIGS. 16A-16E show a situation of an individual length that differs from a multiple of t_{EOFDM}, but it can be imagined that in FIG. 16E, the SYN 510 could be transmitted instead of OFDMA symbol 612A by the master device 10, while the client device 20 transmits the OFDMA symbol 512A, for example. This may be carried out in the cases in which:
1) There is a native orthogonal way to provide both in parallel or
2) There is an orthogonalization, e.g. by a frequency filtering (e.g. upper half of the signal band is for sync & filter frequency guard band, the lower stays for data).

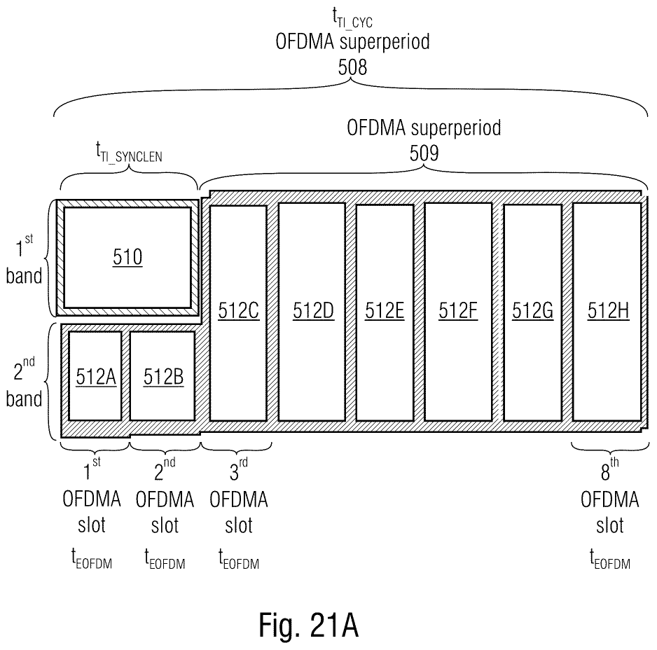

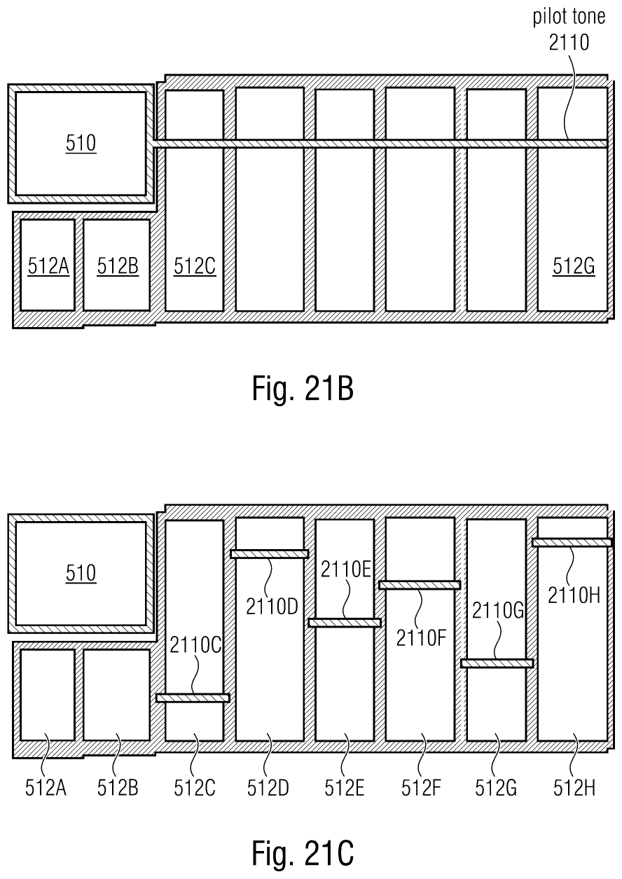

Sending data in parallel improves the system massively in this use case: sending sync elsewise means data delay—hard e.g. to automotive systems. This will be shown later with reference of FIGS. 21A and 21B.

It is possible, that under certain circumstances, such partial band SYN sequence (e.g. see FIG. 21A) may not need to occupy the full time length available in the frequency band. In such case, the SYN sequence is needed to be aligned to end an OFDMA slot or the detection block 248 or a later post processing step (e.g. at 230) need to consider the remaining gap to keep the calculations below valid.

If the synchronization signal 510 is inserted as exclusive synchronization data (thus is not part of the data transmission) (e.g. by designer's choice, or to improve reliability, or because the synchronization signal 510 is not sufficient interference-resistant in the receiver's detection part against the preceding data on the channel, and/or the receivers timing detection based on it performs insufficient timing detection results in case of signal interference), the synchronization signal 510 may, in some examples, be modified in a way changing its length (e.g., might be complemented with a guard interval like in FIG. 13 with or without redundant waveform repetition, e.g. the cyclic prefix or postfix, as inserted by the CP inserter 226 though path 227). Its completely new duration then is to be regarded by t_{TI_SYNCLEN} (synchronization subperiod). (Notably, FIG. 13 has been previously explained as showing an OFDMA symbol sent by the SYNCC 20, and not by the SYNCM 10; however, the insertion of the cyclic prefix or postfix may follow the same technique.)

If the absolute point in time of the first output of a synchronization signal 510 sent by the SYNCM 10 is called T₀, a possible point in time T_{RS} at which a SYNCC 20 is to carry out the action S (i.e. firing a particular OFDMA symbol at the point R (230) after a full synchronization may be calculated as follows:

$${T}_{R S} ( m , n ) = {T}_{0} + n * {t}_{TI \_ CYC} - {t}_{output} + ( m * {t}_{E O F D M} )$$

with n (indicating the n-th OFDMA superperiod 508 starting from the present OFDMA superperiod) being an element of the natural numbers including 0 (numbered OFDMA superperiod 508 including the one related to T₀), and m (indicating the m-th OFDMA slot to be transmitted in the n-th superperiod 508) being a natural number including 0 and smaller than the number of OFDMA symbol slots per OFDMA subperiod 509, thus m being the numbered OFDMA symbol (OFDMA slot) in between two synchronization subperiods. In case of parallel transmission of SYN to OFDMA slots (e.g. see FIG. 21A), the upper bound of the number m is to be increased by the number of OFDMA symbol slot, available parallel to the SYN slot, or alternatively, the lower bound is to be decreased by the number of OFDMA symbol slots available parallel to the SYN slot. The system might be restricted to use m with 0 only (or in case of parallel SYN with the lowest value possible for m) and calculate explicitly or implicitly the “S-processing” of the next symbols (m>0) from this calculated point (design decision). It is to point out the resulting point in time may not become smaller than T₀, because of the practical issue we cannot initialize the action “S” at “R” in past time in a practical system.

To circumvent the necessity of detecting and storing T₀, as well as the long pre-calculation to calculate each future point in time T_{RS} therefrom, as well as possible aging of this information, the last time T_{detect} of receiption of an already received SYN 510 at the reference point R (230) is taken into account, and the output of the next OFDMA symbol portions is indicated by definition of the allowed points in time T_{RS+1} e.g. for the subsequent cycle (superperiod) N+1. This might be limited to the output of the first OFDMA symbol slot after occurrence of the synchronization information, since the following can be determined by a simple calculation of m*t_{EOFDM} (m being a numbered OFDMA symbol to be sent by the SYNCC, starting with m=0 for the first OFDMA symbol) (or comparably if the assumption of same duration t_{EOFDM} does not apply for all OFDMA symbols in a very general case). For example, in FIGS. 16C and 16E, it is not possible for the SYNCC 20 to synchronize the OFDMA symbol 512A to the immediate previous received SYN 510B, because the detection of the immediate previous received SYN 510B occurs in at time instant DT (also indicated with T_{detect}), which happens simultaneously to the transmission of the OFDMA symbol 512A. For this reason, the OFDMA symbol 512A in FIGS. 16C and 16E is synchronized to the last but one SYN 510A received at the previous OFDMA superperiod 508. Accordingly, the allowed points in time in which some OFDMA symbols are to be fired is (see also FIG. 19C):

$${T}_{R S + 1} ( m ) = ( {T}_{d e t e c t} + {t}_{TI \_ CYC} ) - ( {t}_{output} + {t}_{TI \_ SYNCC} ) + ( m * {t}_{E O F D M} )$$

whereas the last bracket (m*t_{EOFDM}) applies to the sentence in front of the formula. If the delays in the formula are that long that the outcome always is negative, it is advantageous (and in some cases even necessary) to calculate the symbol starts for the cycle after the next or even for a later one. This would refer to T_{RS+2} Or T_{RS+N}, introducing a corresponding natural N factor>=2 in front of t_{TI_CYC}. For the formula below, this would introduce an additional summand of (N−1)*t_{TI_CYC}.

If it is wanted and possible to always to use the youngest timing information, following formula is to be applied for all possible values of m, and the latter formula is to be applied only for m-values hint to “S” at “R” cannot (past time) or should not (design decision) be calculated from the following formula:

$${T}_{RSyoungest} = {T}_{d e t e c t} - ( {t}_{output} + {t}_{TI \_ SYNCC} ) + ( m * {t}_{E O F D M} )$$

with the upper definitions of m (or comparable counting of m, if the assumption of same duration t_{EOFDM} does not apply for all OFDMA symbols in a very general case).

As shown by the general calculation for T_{RS}(m,n), due to the cyclic occurrence of the time synchronization information, older synchronization information may also be used. Without limitation, this is not advised due to possible aging of this information (e.g. since SFO is sufficiently compensated, however, not to 0).

Once sufficiently time- and frequency-synchronized, SNYCCs 20 obtain the right to communicate on their allocated OFDMA frequency resources, e.g. provided that all additional conditions not in focus here are adhered to (e.g. allocation of the channel resources to the SYNCC transmitter).

FIG. 19A shows how the time instant T_{RS}(m,n) for firing an m-th OFDMA symbol in an n-th superperiod can in principle be calculated (FIG. 19A only represents the formula for calculating T_{RS}(m,n), without any intention of showing where delay time intervals tₒᵤₜₚᵤₜ and tₚᵣₒₚ₁ occur). If the synchronization symbol (SYN) 510 (510A) arrives at time instant T₀ and is acknowledged as valid synchronization symbol at time instant DT (also called T_{detect}) by the block 248 of the SYNCC 20, then a particular m-th OFDMA symbol (e.g. 512a . . . ) in a particular n-th cycle (OFDMA superperiod) should in principle be fired (from point R, block 230) at time instant

$${T}_{R S} ( m , n ) = {T}_{0} + n * {t}_{TI \_ CYC -} {t}_{o u t p u t} + ( m * {t}_{E O F D M} ) ,$$

where t_{TI_CYC} is the time length of the superperiod 508, tₒᵤₜₚᵤₜ is the fixed, known a priori, time length for processing the transmission (e.g. by 234 and blocks downstream), and t_{EOFDM} is the time length of the OFDMA symbol (OFDMA slot).

However, since T₀ is also impaired by the propagation delay T_{PROP1} (which is the propagation delay from the master device 10 to the client device 20), it is possible to perform the following calculation, introduced by the extended CP duration introduced above:
For the OFDMA symbols which are to be sent in the same n-th cycle (same n-th superperiod 508) (in particular in time instants T_{RSyoungest, 2} and T_{RSyoungest, 3}), it is possible (like in FIG. 19B) to command the transmission of the m-th OFDMA symbol at the time instant T_{RSyoungest}=T_{detect}−(tₒᵤₜₚᵤₜ+t_{TI_SYNCC})+(m*t_{EOFDM}), with T_{detect} being the time instant in which the reception of the synchronization symbol 510 is detected, tₒᵤₜₚᵤₜ being the known delay from the block 234 of the SYNCM 10 and the blocks downstream, and t_{EOFDM} being the time length of each OFDMA symbol (OFDMA slot).
   For example, for firing an OFDMA symbol at time instant T_{RSyoungest, 2}, we have T_{RSyoungest, 2}=T_{detect}−(tₒᵤₜₚᵤₜ+t_{TI_SYNCC})+2*t_{EOFDM}
   for firing an OFDMA symbol at time instant T_{RSyoungest, 3}, we have T_{RSyoungest, 3}=T_{detect}−(tₒᵤₜₚᵤₜ+t_{TI_SYNCC})+3*t_{EOFDM}
(it is noted that FIG. 19B does not intend to show the exact position in time of Tₒᵤₚᵤₜ and t_{TI_SYNCC}, but only show how to calculate the positions T_{RS+1}, T_{RS,YOUNGEST, 2}, T_{RS,YOUNGEST, 3}, etc).
A similar depiction is offered by the FIG. 15, that shows the alternative to FIG. 16C and calculates the youngest both OFDMA symbol possible to carry out based on the preceding DT (also T_{detect}), showing the transmission can start even earlier, here with m being 1 and m being 2.
For the OFDMA symbols which are to be sent in the subsequent (n+1)-th cycle (superperiod) (like T_{RS+1} in FIG. 19C), the calculation for the m-th OFDMA symbol to be fired is T_{RS+1}(m)=(T_{detect}+t_{TI_CYC})−(tₒᵤₜₚᵤₜ+t_{TI_SYNCC})+(m*t_{EOFDM}), like in FIG. 19B with T_{detect} (also called DT) being the time instant in which the synchronization symbol 510 is detected, T_{TI_CYC} the time length of the OFDMA superperiod 508, m the progressive number of the m-th OFDMA symbol to be transmitted, tₒᵤₜₚᵤₜ the known delay from the block 234 and the blocks downstream, and t_{EOFDM} the time length of each OFDMA symbol (OFDMA slot).
(it is noted that FIG. 19C does not intend to show the exact position in time of Tₒᵤₚᵤₜ and t_{TI_SYNCC}, but only show how to calculate the positions T_{RS+1}(0), T_{RS+2}(0), etc).
In this way, the OFDMA symbols can reach the master device 10 (and in principle any client device) after the time delay t_{TI-CYC}+tₚᵣₒₚ₁+tₚᵣₒₚ₂ (in correspondence of the window 530 in FIG. 16G).

For the reasons above, it may be that, for each superperiod 508 (e.g. the n-th superperiod):
At least the first OFDMA symbol that is to be transmitted (e.g. 512a in FIG. 16E) may be transmitted based on synchronization obtained from the synchronization signal 510 in the previous superperiod 508 (i.e. the (n−1)-th superperiod) (i.e. like in FIG. 19C, and is transmitted in time instant t_{RS+1})
   (it is possible that also a second, a third, etc. OFDMA symbols are also transmitted based on the synchronization signal from the (n−1)-th superperiod; the second OFDMA symbol 512B would be transmitted in time instant t_{RS+1}(2) in FIG. 19C)
At least the last OFDMA symbol (e.g., from the second OFDMA symbol 512B to the last one) that is to be transmitted is transmitted based on synchronization obtained from the synchronization signal 510 in the same superperiod (i.e. the n-th superperiod) (i.e. like in FIG. 19B) and is transmitted in time instant t_{RS,youngest, 1}, t_{RS,youngest, 2} etc. in FIG. 19B.

It is to be noted that the cyclic prefix or postfix of the synchronization signal transmitted by the master device 10 and/or by the client device(s) 20 may be of at least two times the maximum propagation time t_{d} (e.g. equal to tₚᵣₒₚ₁=tₚᵣₒₚ₂) associated with the maximum distance between the master device 10 and the client device(s).

### Processing Part 3: Tracking/Keeping Synchronous the SYNCCs 20

Once the initial synchronization with respect to the desired metrics (timing and/or SFO and/or CFO) has been achieved, the transmission frequencies (sampling and/or carrier frequencies) of the SYNCCs 20 may be tracked on the basis of the sufficiently evaluated synchronization information received last since they may change in operation (e.g. by heating of reference oscillators usually not temperature-controlled, or e.g. by a change of channels lengths between two nodes in case of mobility in wireless systems).

The time synchronization may be implemented as a continuous process as well. For steadily being kept synchronous, the above calculation (T_{RS+1}, and others) may be carried out as a continuous process during the runtime, on the basis of the most recent time synchronization receipt information usable under practical aspects (e.g. physically: negative time offsets T_{RS+1} cannot be realized; or e.g. implementation-related use of the second-oldest information to reduce effort).

Thus, tracking the time and frequency synchronization may be carried out in the ongoing transmission operation as well. After achieving the right to transmit (after the initial synchronization), tracking usually does not lead to withdrawal of the right to transmit. However, if too large of a time or frequency offset is determined, the right to transmit may be withdrawn at the next synchronization (design decision of the system engineer).

Some concepts on the present invention with the present examples we offer a time and frequency synchronization technique for OFDMA communication devices (one master device 10 & many client devices 20s) using a common band for data transmission and reception for multipoint-to-multipoint communication.

OFDMA in general needs fine frequency (carrier, sampling) synchronization (in theory it would be perfect to have ideal decoding conditions) and a valid time synchronization (within limits but not perfect when using CPs, prefix/postfix) between all device 10 and 20 sending into the same band.

The channel thereby has limited size (maybe artificially limited if not naturally), but allows to decode the data signal assembled from at all devices 10, 20 in any positions within the common Rx-Tx channel. The OFDMA signal is assembled within one frequency band to be kept with orthogonal signals to be commonly decodable.

Prior art OFDMA systems (e.g. LTE) communicate point-to-multipoint (downstream to distributed devices) or vice versa (upstream) with fixed nodes (LTE: Base stations, other: etc.) and the bands are sufficiently frequency divided (in the case of FDD) or time divided (in the case of TDD) or both (e.g. having an upstream frequency band and a downstream frequency band). At least they only need the possibility to receive a signal from the “base stations” at the distributed devices, and signal from the distributed devices at the “base-stations”. Thus, the signal from the devices only needs to be orthogonal at the “base stations”, and “base stations signals” need to be orthogonal for the devices.

The present examples can work as follows:
1) preconditions are defined (channel size, sufficient orthogonality=time/frequency synchronicity−to be decided by the designer), the devices 10 and 20 are frequency synchronized
2a) to be able to communicate into the common communication band for reception & transmission by tuning the own same-band-transmission based on the SYN reception to the master device 10.
2b) There may also be a time-synchronization (2b) to the SYN reception of master device 10 to the common reception-transmission-band in a way the OFDMA signal is decodable everywhere in the channel to everyone.
3) Now the client devices 20 have the right to send on their own to everyone, and synchronicity is maintained even if the internal clocks of the devices 10 and 20 drift (e.g. since devices 10 and 20 may warm up, cool down, may move and therefore underlay doppler-shifts, malfunction, etc.)

Therefore, as in passages 2a, 2b a core is tuning the own Tx by SYN Rx delivered beside data in the common band.

### Additional Aspects of the Present Examples

How the SYN 510 looks like (but only offering the possibility to measure frequency/time/offset of)
How do the devices measure metrics based on SYN in 248 (248 may be divided/distributed; many methods are SoA)
How the devices decode signals (but only they are still orthogonal and thus offer the possibility)
How the OFDMA transceivers look like beside the core synchronization structure (248, 249, 230, 251, example-wise 248EV, 251b for delivering and processing 251, and also example-wise 251=>230 in FIG. 3E, and 238, 240 as a mandatory part for a digital transceiver, but not necessarily with one each channel only)
How exactly the frequencies are tuned at the Tx (just that they are corrected since there are a bunch of possibilities. The example FIG. 4B thereby is reasonable)

### Some Advantage of the Present Techniques

OFDM and OFDMA systems established today are used efficiently in the wireless range (OFDM: e.g. DFB and IEEE 802.11ac; OFDMA: e.g. 4G and 5G mobile communication, IEEE 802.11.ax) and in wired systems (OFDM: e.g. G.9960, VDSL; OFDMA e.g. DOCSIS upstream), especially in case of highly band-limited channels. Here, OFDMA provides great scalability with respect to the channel resource allocation to individual devices and further increased efficiency (TDMA requires exclusive guard times per channel slot switch, OFDMA shares this guard time with all simultaneously active communication partners). In addition, there is efficient common demodulation of all channel resources by the distributed transmitters by means of IFFT. However, so far, conventional OFDMA systems do not enable MP2MP communication, which further increases the efficiency of the channels (vs. OFDM: see above, vs. conventional OFDMA: direct communication instead of upstream first and then downstream). Anyhow, like yet established OFDM and OFDMA systems, MP2MP-OFDMA system have high synchronization requirements. Other than the established systems, MP2MP-OFDMA needs to regard different synchronization demands due to the need to of maintaining the subcarrier and OFDMA-symbol orthogonality at all device positions to enable high data transmission quality between them. The technique described enables this feature at all possible device positions within the channel.

### FIELD OF APPLICATION

Communication scenarios with predominant direct communication and large channel division can be found in “IoT” area: vehicle communication (intra-vehicle, potentially: V2V, V2I, infrastructure-backend), aircraft communication (intra-plane) and in the industrial area (e.g. factory automation).

### BIBLIOGRAPHY

[21] M. Speth, S. A. Fechtel, G. Fock and H. Meyr, “Optimum receiver design for wireless broad-band systems using OFDM. I,” in IEEE Transactions on Communications, vol. 47, no. 11, pp. 1668-1677 November 1999, doi: 10.1109/26.803501.
[22] M. Morelli, C.-C. J. Kuo and M.-O. Pun, “Synchronization Techniques for Orthogonal Frequency Division Multiple Access (OFDMA): A Tutorial Review,” in Proceedings of the IEEE, vol. 95, no. 7, pp. 1394-1427 July 2007, doi: 10.1109/JPROC.2007.897979.
[23] M. Speth, S. Fechtel, G. Fock and H. Meyr, “Optimum receiver design for OFDM-based broadband transmission.II. A case study,” in IEEE Transactions on Communications, vol. 49, no. 4, pp. 571-578, April 2001, doi: 10.1109/26.917759.
[24] T. M. Schmidl and D. C. Cox, “Robust frequency and timing synchronization for OFDM,” in IEEE Transactions on Communications, vol. 45, no. 12, pp. 1613-1621 December 1997, doi: 10.1109/26.650240.
[25] Hlaing Minn, V. K. Bhargava and K. B. Letaief, “A robust timing and frequency synchronization for OFDM systems,” in IEEE Transactions on Wireless Communications, vol. 2, no. 4, pp. 822-839, July 2003, doi: 10.1109/TWC.2003.814346.
[26] [26] Byungjoon Park, Hyunsoo Cheon, Changeon Kang and Daesik Hong, “A novel timing estimation method for OFDM systems,” in IEEE Communications Letters, vol. 7, no. 5, pp. 239-241, May 2003, doi: 10.1109/LCOMM.2003.812181.

### Common Use of Cyclic Extensions by Example (SoA)

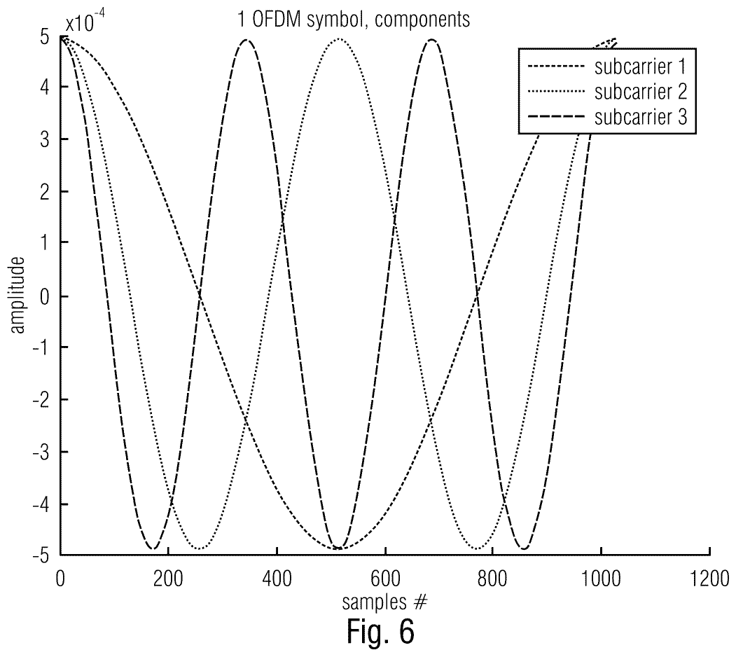

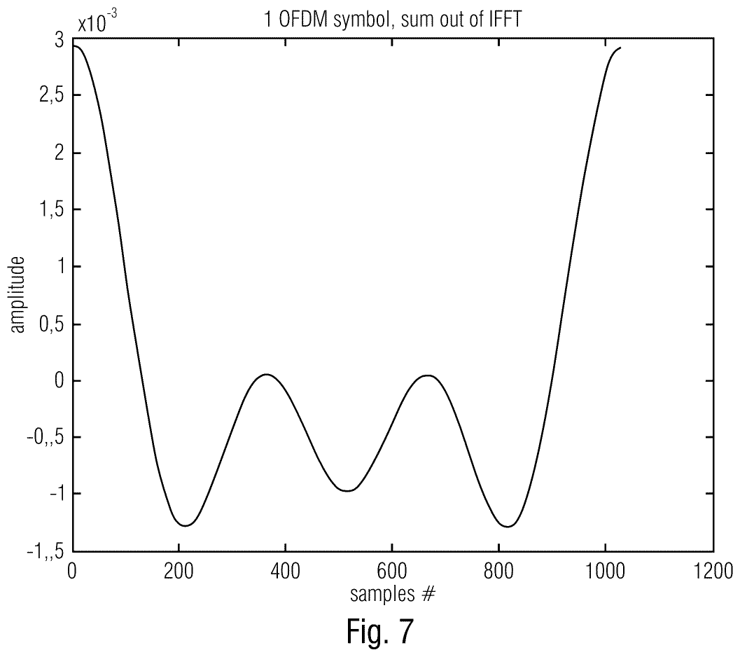

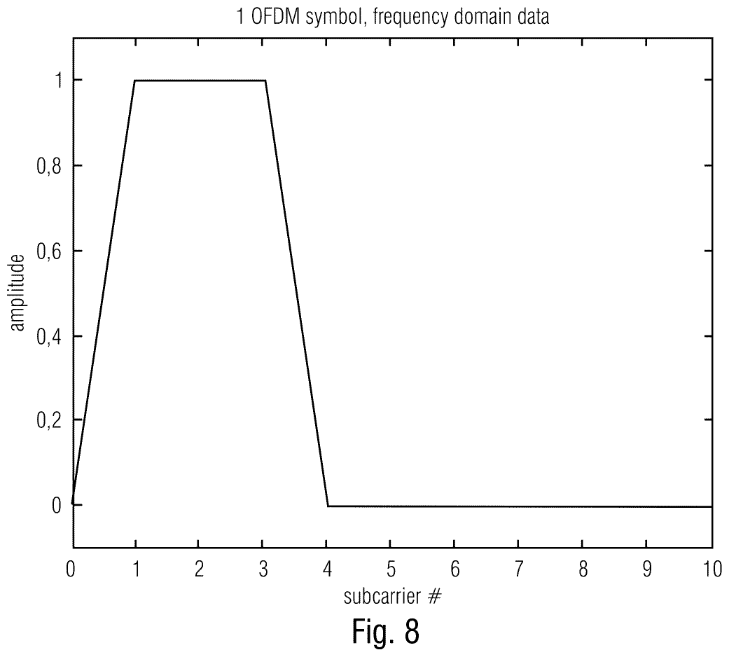

In the example scenario, an OFDMA signal is to be sent, that may contain the value “1” (for now, this might be data) in the first 3 non-zero orthogonal frequencies (FIG. 6 show the time domain subcarrier components, FIG. 7 the resulting OFDM/A data, that adds up the components, FIG. 8 the spectral representation (just for the first out of 512 DMT/out of 1024 OFDM/A subcarriers)). OFDM/A (and also DMT) modulation is commonly done by an Inverse Fast Fourier Transform (IFFT), e.g. as performed by IFFT block 220. No cyclic extension was added to the signal yet.

Annotation: For easier description and depiction, data shown in the figures is “Discrete Multitone Modulation” (DMT) data, represent the real-valued form of OFDM. Subcarrier count then is reduced from 1024 to 512 subcarriers, since subcarrier data has to be reduced to half of its amplitude on subcarrier n, and repeated in its reduced amplitude form and complex conjugated on subcarrier 1024-n. Subcarriers itself can carry complex-valued information on the real-valued signal. Anyhow, we speak about OFDM/A data and 1024 subcarriers below to keep the description general.

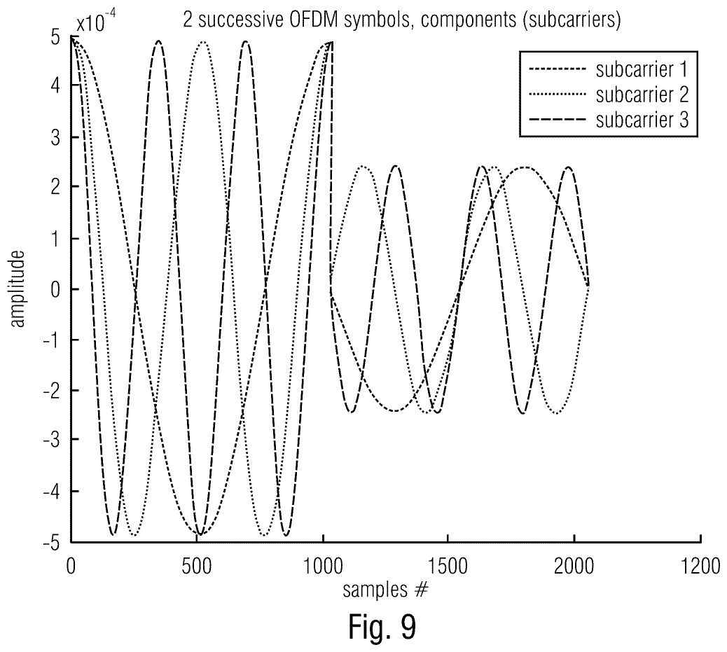

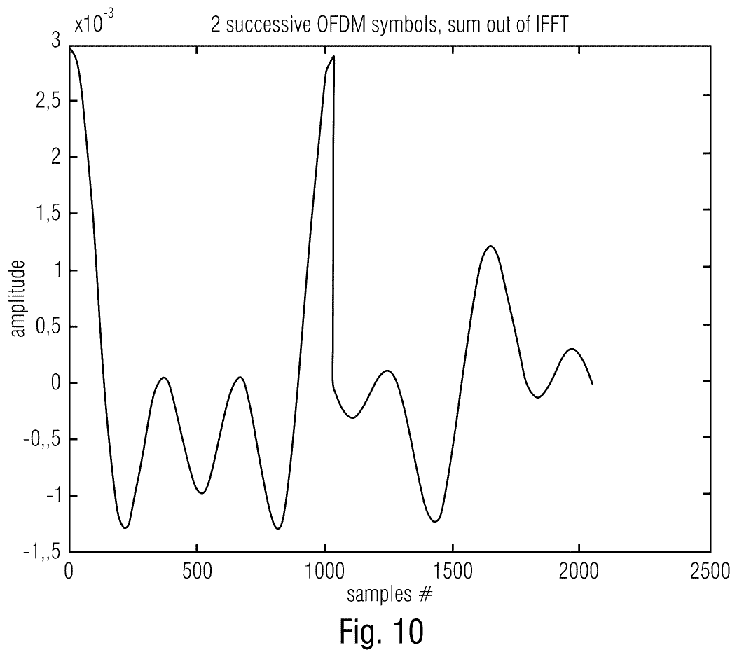

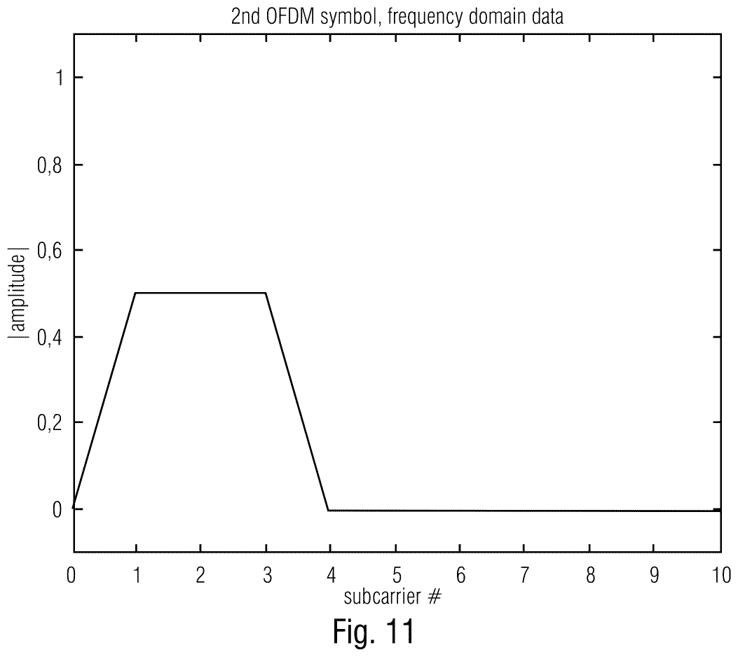

Since it is not practical just to send data once, afterwards it is possible (e.g. in FIG. 9 as separated time domain subcarrier components, in FIG. 10 as OFDM/A time domain signal) to send the complex-valued subcarrier data 0.5*e\hat{ }(j*π/4), 0.5*e\hat{ }(j*3*π/4), 0.5*e\hat{ }(j*5*π/4) and present the same time domain data, as well as the absolute values of the frequency domain data of the 2^{nd} OFDM/A symbol. The frequency domain data of the 2^{nd} symbol is depicted in FIG. 11.

Now the corresponding decoding window in the reverse-acting Fast Fourier Transform (FFT) (e.g. FFT block 252) could be missed, or we may have multipath propagation of different delays in the channel (e.g., due to reflections) and thus cannot find a decoding window fully containing data from just one OFDM/A symbol, but e.g. also from the previous OFDM/A symbol.

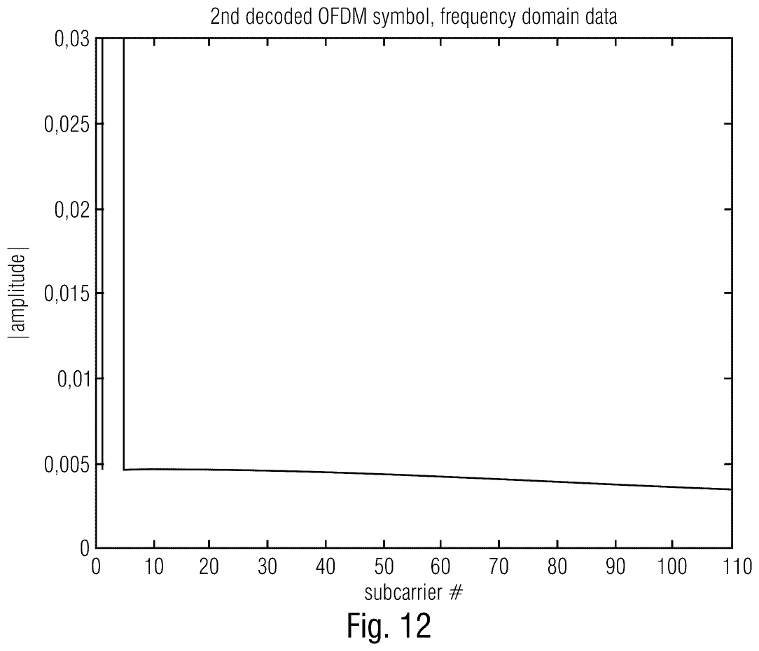

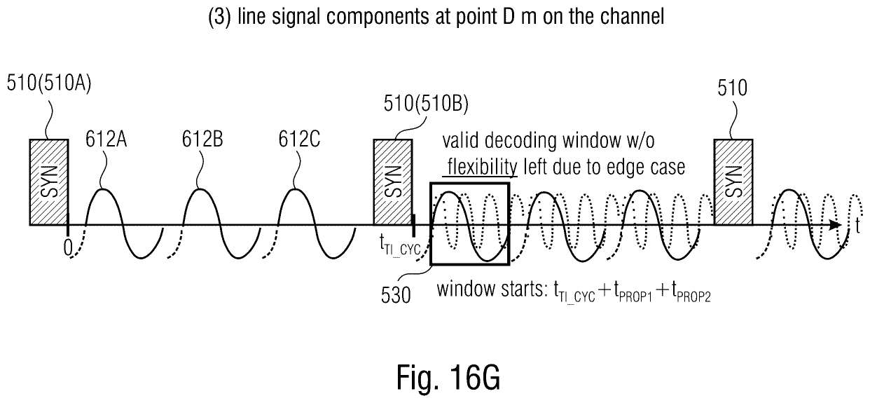

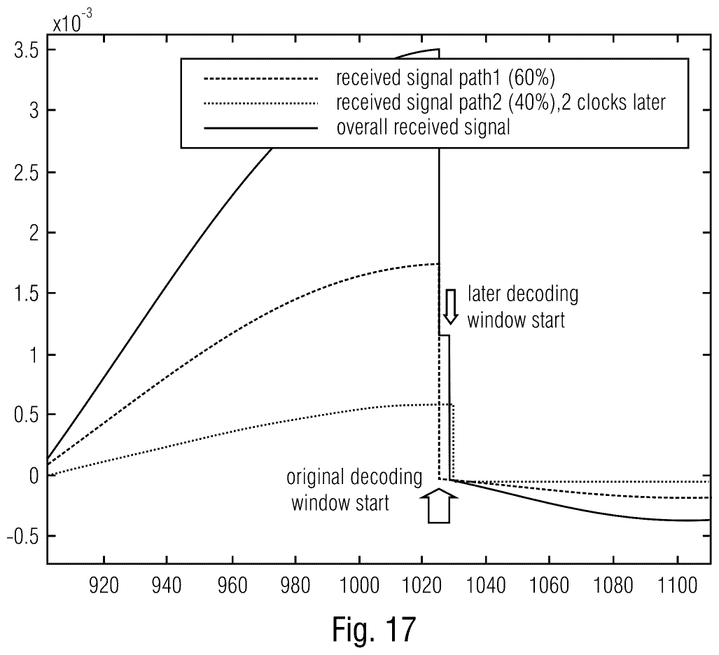

(FIG. 12 shows the difference in frequency domain data compared to FIG. 11, when being 5 samples early Just to be early by 5 samples on the 2^{nd} symbols in FIG. 10, it is recognizable, that inter-symbol-interference from the preceding symbol leads to wrong decoding values, depicted in FIG. 12. Signal power occurs even on subcarriers, unused by both symbols. Also, the original carriers are interfered (not recognizable by this depiction). For a multipath condition depiction, See for example FIG. 17, where the second propagation path causes a 5 samples delay compared to the first one.

One can recognize, other carriers, might be used by other devices 20 in an OFDMA system, are interfered (low portion from 3 carriers, but we have up to 1024 in the system).

For such reasons, cyclic extensions (CE, e.g., cyclic prefixes (CP) or cyclic postfixes) are introduced (e.g. in CP insertion block 226), possibly introducing phase offset data, but no inter-carrier-nor inter-symbol-interference if the decoding window is handled properly.

The CP is a copy of the OFDMA symbol's end in front of its start (while the cyclic postfix is a copy from the original OFDMA symbol start placed at the end of the OFDMA symbol). The cyclic time domain definition (windowed for decoding) of limited frequency domain data (e.g. 1024 FD values, i.e. mostly 0 in this example) allows this action and just results in the mentioned phase shift of both, the overall signal, and its single frequency components. This is reversible by low complexity OFDM equalization techniques (e.g., widely spread: one tap frequency domain equalizer).

In this example picture, the CP may be chosen (e.g. by the CP insertion block 226) to be a copy containing 50 symbol's end samples (FIG. 13, instead of 50, a different number may be chosen that is appropriate to support the channel size for the individual device-to-device multiple paths in MP2MP-OFDMA, as well as additionally supporting other system properties, e.g. uncertainty of the timing method or multipath between single device-pairs). In the case of multipath example picture (FIG. 17), where the delay spread is 5 samples, we have the choice of 45 non-interfered and thus valid remaining decoding windows, starting from sample 6 of each CP extended symbol.

The upper descriptions is based on the multipath case. It is to point out, that other cases a CycE is useful, e.g. like residual but acceptable SFO values after synchronization or residual uncertainty in the timing detection (for finding the decoding window), might lead to positive or negative decoding window offset assumptions. So in general it is not sufficient just to choose the last 1024 samples out of the valid decoding range.

The present examples may use the cyclic extension for further purposes, presented in section “Extended cyclic extensions for the invention and edge case timing example”.

### Extended Cyclic Extensions for the Invention and Edge Case Timing Example

Section “Common use of cyclic extensions by example (SoA)” showed the common usage of cyclic extensions (CycE) inside a guard interval. Beside the common usage, the invention uses the CycE for introducing flexibility in superposing OFDMA signal portions, generated by distributed communication devices (the SYNCM 10 and the SYNCCs 20) to be communicated potentially from each device to each other device. Anyhow, if this edge case of a full mashed broadcast scenario does not apply until final decoding, OFDMA-systems most commonly introduce a sole full band FFT decoding block 252 in each device for bringing all data received back to frequency domain at once as a first OFDM/A demodulation step to keep up flexibility and to avoid elsewise additionally necessary filters. In a processing step afterwards it is then decided to discard some data of no interest. Thus, this MP2MP-full-mesh communication applies for the first processing steps.

At first, the relevant parts of a transmitter pipeline 200A and receiver pipeline 200B is introduced as an example implementation description.

The transmitter pipeline 200A may modulate its data to the subcarriers, allocated to the concrete instance with an IFFT (IFFT block 220). Afterwards, the necessary portion (regarding Annex B1 and B2) of CycE as a CP is added in front of each OFDMA symbol portion 226. This is always true for a SYNCM 10 and true for fully synchronized SYNCCs 20. In this example, the output 227 of the CP block 226 is multiplexed (230) with time-domain synchronization data for the SYNCM 10, and with an equal length pause for synchronized SYNCCs 20. It is to point out: Synchronization data might be generated in frequency domain (in front of the IFFT, then the multiplexer needs to be placed accordingly) or might be data based on the SYNCM's data signal or might only occupy a certain frequency range and the IFFT just have to leave out the corresponding frequencies. For further description, it is stayed with this full-bandwidth time domain example. After the multiplexing (in the time-triggered or event-triggered gate 230 if in the SYNCM 10, or in the timing synchronization control block or time-triggered or event-triggered gate in the SYNCC 20) which has generated a multiplexed signal 232 in the SYNCM 10 (or gated signal 232 in the SYNCC 20), further processing steps might be applied (e.g. the frequency upshift 234 including upsampling and/or driver-passing of the DAC, to obtain an upshifted signal 236), until the Digital-to-Analogue-Converter (DAC) 238 generates the output signal and applies the generated signal to the channel. Parts of the analogue frontend behind the DAC might also have a fixed delay, that is later regarded. The receive path 200B of every device 10 and 20 listens to the channel, passes the analogue receiver part frontend and digitalizes all received data, then passing the resulting samples into the receivers DSP. After possibly necessary, but fixed-delay DSP actions (e.g. downshift 244 e.g. including downsampling, to obtain a downshifted signal 246), the synchronization block 248 may search for synchronization metrics in the time-domain. Evaluated this possibly against the frequency offsets CFO and SFO first (if chosen by implementation to use the invention this way too), block 248 aligns the local transmitter frequencies of the SYNCCs 20. If not chosen this way, the transmitter 200A may align its frequencies in another way. Optionally, block 248 of the SYNCC 10 could also align the local receiver frequencies to adapt reception. The time and frequency synchronization detection block 248 may also search for the timing-metric and forwards the timing synchronization information (249) to the FFT block 252 to communicate a valid decoding window, and (as a central point of the present technique), it informs the local transmitter 200A (e.g. through frequency information 251 and/or timing information 249) about it to inform the SYNCCs sender (transmitter side) 200A about valid OFDMA symbol portion starts.

Regarding the description of the invention, the “point R” (227) is at the devices displayed multiplexer 230, where “action S” could be the decision when to send the start of the next CP-extended OFDMA symbol portion after the signal gap introduced for the SYNCM's SYN signal for the SYNCCs, and after the SYN information for the SYNCM correspondingly.

### Description of FIGS. 3A, 3B, 4A and 4B

The difference between FIGS. 3A, 4A and 4B are here discussed. FIG. 3A shows a device which may be a client device 20 or a master device 10. In the client device 20, block 222 and path 224 are not present or are deactivated. Block 230 may be avoided or may be considered simply an element which is commanded by block 248 through command 249. FIG. 3A shows path (e.g. command) 249 as representing the transmission characteristic (or a command based on the transmission characteristic) that represents the timing for transmitting the OFDMA signal in the correct OFDMA symbol. The synchronization (in particular the adaption of the transmission of the next OFDMA symbol in the next OFDMA slot) to the transmission characteristic may be understood as being performed at block 248. Therefore, path 249 may be understood as a timing information which commands firing of the OFDMA signal (subsequent blocks 230, 234, and 238 are understood as being subjected to the fixed delay Tₒᵤₜₚᵤₜ). FIG. 3B shows the example of FIG. 3A but with a distinction between the signals that are transmitted only in the client device 20 and those that are transmitted only in the master device 10. In particular, the block 222 and the path 224 are only present (or activated) in the master device 10. The path 224′, 249, 251 and 251′ may be only present in a client device 20, while the remaining paths or blocks 232, 236, 202, 206, 210, 218, 221, 227, 214, 242, 246, 250, 254, 258, 262 and 264 are both in the master 10 and the client 20. In particular, the signal 224′ (e.g. a constant 0) can be understood as being used in the client device 20 instead of the synchronization signal 224 (the signal 224 will become the synchronization signal 510). This is because the multiplexer inputs of block 230 in the client device 20 sends no synchronization signal 510 (that's why it is considered a constant 0 in the client device 20; in case of partial band synchronization information, this might be carried out in front of the IFFT). It is notwithstanding to see that a timing information 249 and a frequency information 251 may be provided from block 248 to the receiving side 200A of the client device 20. The signal 249 may be understood as the time in which each OFDMA signal (e.g., 512A, 512B, 512C) is to be fired, and the frequency signal information 251 may be FIG. 4A provide the information on the time lengths of the signals (e.g. the time length of the OFDMA slots). FIG. 4A shows an example analogous to the that of FIGS. 3A and 3B, but with some enlarged portions. It is to be noted that in FIGS. 4A and 3B there is shown also that the frequency 251 is optionally also used for the receiving pipeline 200B by the path 251′ and not only for the transmitting pipeline 200A.

FIG. 4B shows another example in which a metric evaluation block 248EV receives a frequency information and measures frequency information and provides the frequency common to both the resealing pipeline 200A and the transmitting pipeline 100B, as well as to the DAC 238 and the ADC 240.

### Example of FIGS. 21A-21C

FIGS. 21A-21C show further examples. FIG. 21A shows that it is possible for the SYN 510 sent by the SYNCM 10 to occupy a first band for one or more OFDMA symbol slots, while simultaneously at least one OFDMA symbol (e.g. 512A, 512B) are simultaneously transmitted by the SYNCC 20. In this case, t_{TI_SYNCLEN}=2*T_{EOFDM} (remembering that t_{EOFDM} is the time length of one OFDMA slot, and t_{TI_SYNCLEN} is the time length of the SYN 510). It has been pointed out in the upper text, that a) such partial band sequences need to end directly in front of an OFDMA symbol or the processing needs to consider offset between the SYN and the start of the next OFDMA symbol, and b) The formulas T_{RS}, T_{RS+1} and T_{RSyoungest} may be modified to also reach the OFDMA symbols occurring in parallel to the SYN. (FIG. 21A shows that the first band occupied by the SYN 510 is higher than the second band occupied by the OFDMA symbols 512A, 512B, but a different configuration may be possible. Further, while FIG. 21A shows that the first two OFDMA slots are occupied by the SYN 510, it may be placed also in other OFDMA slots.) Therefore, the SYNCC 10 may transmit the OFDMA symbols 512A, 512B, and simultaneously receive the SNY 510. The SYNCC 20 may determine the transmission characteristic as having both timing information (e.g. 249) from the occurrence of the detection of the reception of the SYN 510 and frequency information (e.g. 251), e.g. from the subcarriers of the SYN 510 or e.g., from the time difference between detected successive SYNs or aggregates of it (in general: any technique able to extract frequency or frequency offset information from a SYN, from a part of the SYN or from multiple SYNs or parts of multiple SYNs). The last OFDMA slots (e.g. 512F-512H, and maybe also 512D-512F) may be synchronized on the current SYN 510, while the OFDMA slots (512A and 512B, and maybe also 512D-512F) simultaneous to current SYN 510 may be synchronized on the previous SYN (not shown in FIG. 21A).

FIG. 21B shows the same of FIG. 21A, but in this case at least one pilot tone 2110 at known frequency (constant among the OFDMA symbols 512C-512G which do not present the full band of the SYN 510) for exclusive or further frequency synchronization and possibly reused for further equalization is transmitted by the SYNCM 10 and received by the SYNCC 20 for equalization. The SYNCC 10 may therefore use the at least one pilot tone 2110 as reference for equalization. It thereby is not necessary that the pilot tone(s) occur inside the band or parts of the band the SYN part 510 occur in. However, it has been understood that it is of advantage to have, for consecutive OFDMA slots which are not simultaneous to any SYN 510 (like 512C-512H), to have multiple pilot tones 2110C, 2110D, 2110E, 2110F, 2110G (zero to multiple pilot tones for each OFDMA slot 512A-512H which is not simultaneous to any SYN 510) at difference frequencies according to known frequencies. In this way, the SYNCC 20 can perform further frequency synchronization and also general equalization by accounting on the multiple tones 2110C-2110H.

In case of having pilot tones as part of the SYN, either in case of FIG. 20B or 20C) it might be appropriate, but not mandatory for any system implementation, to reserve neighboring subcarriers to the pilot tone that are kept free from data, to keep the tone free from data interference and possibly also vice-versa (e.g. in case of doppler-shift by sudden rapid movement, or e.g. in case of sudden warmup, cooldown, or e.g. in case of a highly reactive frequency control loop. In general: Any case of awaited interference of neighboring subcarrier, contra-productive to the measurement)

The SYN 510 also might change in bandwidth during its occurrence [e.g., switching from a multi-subcarrier representation to pilot tones], whereas resources reserved for SYN are known by every system device, SYNCM and SYNCCs. Then the transmission pause applies just inside of the band currently foreseen for the SYN, same for every synchronization superperiod 508, and possible additional filter bands needed to divide the SYN from the data inside processing block 248. For this scenario, a description can be found below and the FIGS. 21A-21C show corresponding scenarios.)

### Implementation in a System

It is possible to implement a system [e.g. for multipoint to multipoint communication] comprising the master device 10 and a plurality of the client devices 20. The master device 10 transmits the SYN 510 periodically. Each of the client devices 10 derives a transmission characteristic [e.g. timing, frequency, carrier, sample clock] on the basis of the received SYN 510 and to adapt a subsequent transmission 512A, 512B, 512C to the derived transmission characteristic.

The master communication device may be further configured [e.g. in an OFDMA subperiod], to
generate, for each symbol (which could be an OFDMA symbol, but it could also not be a OFDMA symbol), the initial cyclic extension (e.g. cyclic prefix) 512D′, 512E′ in which there are copied the last samples of the OFDMA symbol and/or
generate, for each OFDMA symbol of the sequence of OFDMA symbols, a final cyclic extension in which there are copied the first samples of the OFDMA symbol.

The master device 10 and/or client device 20 may be in an electronic unit. The electronic unit may encode at least one sensed value [e.g. obtained from a sensor, e.g. comprised in the electronic unit] in the at least one subsequent transmission. The electronic unit may control at least one actuation [e.g. performed by an actuator, e.g. comprised in the electronic unit] from at least one received transmission. It is possible that one first client device 20 is a sensor device which encodes sensed devices in the OFDMA symbols 512A-512C, and another client device 20 controls an actuator devices which performs actuations based on the data received OFDMA symbols (e.g. like 512A-512C). One client device may be a controller unit, which for example receives data from the sensor device and, based on the data received, transmits commands (e.g. through OFDMA symbols 512A-512C) to the actuator device. a master device 10 may be used for performing the synchronization.

In a system with the master device 10 and a plurality of client devices 20, it is possible to perform the multi point to multi point communication discussed above. By using the synchronization as discussed above (e.g. as shown in FIGS. 15-16G, or more in general based on adapting the transmission characteristic), different client devices 10 transmit and receive OFDMA symbols with each other, without uplink and downlink. For example, with reference to FIGS. 16A-16F, a first client device 20 may send the first OFDMA symbol 512A to a second device 20, and the second device receives the first OFDMA symbol 512A, and transmits the second OFDMA symbol 512B to the first communication device 29 or to another communication device 10 or 20. In general terms, all the client devices 20 may receive the same synchronization signal 510, and may synchronize to it. After that, each client devices 20 will transmit or receive the OFDMA symbols in predefined OFDMA slots.

### An Automotive Communication Bus Using OFDMA

Today's automotive communication systems use baseband pulse modulation and time-division or carrier-sense multiple access. In future in-vehicle networks, more devices need to be connected in a multipoint-to-multipoint topology. We have developed a new automotive bus system based on orthogonal frequency division multiple access (OFDMA) enabling better channel adaptation and fine-granular multi-user access. We highlight the advantages of OFDMA in automotive and industrial applications, introduce our system concept and demonstrate its feasibility by means of a prototype. Finally, we discuss the use of electrical and optical media.

Keywords: OFDMA, Multipoint, MP2MP, IVN, Automotive, Bus, Synchronization, OFDM

### INTRODUCTION

Motorized vehicles involve numerous communication connections between Electronic Control Units (ECUs), sensors and actors today. Many ECUs need to communicate with each other [1]. This establishes a meshed in-vehicle network (IVN) with more than 100 devices in modern cars [2]. The number of nodes and average amount of data per node increased over time as vehicles became increasingly equipped with intelligent functions. This development is accelerating as the trend toward autonomous emerges. To reduce the increasing complexity, especially in the wiring harness, car manufacturers have recently introduced a new zonal architecture [3], which requires flexible high-speed multipoint-to-multipoint (MP2MP) links for backbone connectivity. Currently, switched Automotive Ethernet is used. Automotive Ethernet was adopted from conventional Ethernet, modified and completed for automotive demands e.g., by using single-pair full-duplex communication (integrated into [4] from IEEE Std 803.3 bp/bw). Classical bus systems like LIN, CAN and FlexRay are used intra-zone and often bridged through the Ethernet backbone network when used in other zones.

Many functions in a car contribute to the backbone communication realizing the automotive applications. For these applications, target parameters are data rate and end-to-end latency, which presents the intuitive—yet not practical—solution to provide parallel physical lines for each function. A more common approach is to multiplex all traffic on a single Ethernet link, natively using first-come first-served statistical time division multiplexing. This requires substantial overprovisioning i.e., offering significantly more data rate than needed, e.g., by using 1 Gbit/s instead of 100 Mbit/s line speed. Efficiency increases in general by reducing congestion, i.e., avoiding mutual blockage of message exchanges. This is possible by careful traffic planning, overcoming the statistical multiplexing approach. However, it requires knowing all functions and their communication needs in advance, including line rates and priorities (see, for example, FIG. 11 in [3]). Traffic planning cannot guarantee strict latency constraints without time sensitive networking (TSN) support, defined in IEEE Std 802.1, which adds substantial complexity to the network design and to the devices.

An alternative is deterministic multiple access techniques applied directly in the medium access control (MAC) layer, such as time-division multiple access (TDMA) and orthogonal frequency-division multiple access (OFDMA). Instead of TSN-guided statistical multiplexing, these MAC protocols divide the communication medium into logical sub-channels natively, which are scheduled in a deterministic manner among multiple transmitters using the same bus.

Both, TDMA and OFDMA, allow quality of service (QoS), i.e., to fulfill the required data rates and latency constraints for multiple services operated in parallel over the same medium. However, TDMA requires signals to introduce the maximum guard time between consecutive packets to cope with different propagation delays. E.g., 100 different packets need 100 times this guard interval. When using OFDMA, the signals are mapped on different frequency sub-bands in an orthogonal manner, and hence, can use the same guard interval. This enables more efficient use of the shared medium. One can assign different frequency sub-bands to different signals transmitted in parallel, as mentioned above using parallel physical lines. Hence, the OFDMA approach will significantly reduce the planning effort for the various IVN traffic.

Because of these advantages, we propose a logical multi-channel approach using OFDMA. This divides the communication medium into several, independent channels on orthogonal sub-bands in the frequency domain, moving effort from complex scheduling to simple frequency assignments to the individual signals sharing the automotive bus. All this can be realized by well-known physical layer (PHY) digital signal processing (DSP) processings widely used in 4G, 5G mobile radio, Wi-Fi 6, as well as DOCSIS (Version 3.1 and newer) from the wireless and wired worlds, i.e., addressing huge mass markets. Besides superior channel adaptation capabilities, OFDMA offers high degrees of freedom and can be scaled to high numbers of parallel signals. In addition, it can be used in the bus topology (or transparent daisy chain topology) like CAN and FlexRay. Same as Automotive Ethernet, OFDMA supports high speed, and it removes the need for switches.

An objective of this document is to introduce our OFDMA system concept for future automotive bus systems and identify major challenges for implementation. Therefore, we develop an experimental prototype and report initial measurement results. The main findings are that i) nodes attached to an OFDMA bus need strict symbol synchronization like the existing point-to-multipoint (P2MP) OFDMA systems mentioned above, and ii) there are specific requirements for the MP2MP bus system proposed here.

The section is organized as follows: Section “SYSTEM CONCEPT” presents the system concept, focusing on the PHY DSP. Section “DEMONSTRATOR” introduces the demonstrator and measurements are presented and discussed in the subsequent Section “MEASUREMENT RESULTS”. Section “CONCLUSIONS AND OUTLOOK” summarizes the results and gives an outlook onto future work.

### System Concept

### Physical Channel

To address the automotive use-case, the channel uses Gigabit Switched Automotive Ethernet Cable (Leoni DACAR 647 UTP with MATEnet jacks). An analog frontend (AFE) printed circuit board (PCB) that can be connected to identical PCBs using cable sections in a daisy-chain topology via two MATEnet plugs enables MP2MP on the shared point-to-point medium. A short stub on the AFE PCB adds transmitter (Tx) and receiver (Rx) medium access through amplifiers aiming to keep reflections low. The front-end concept is similar to the solution in [5]. Reference [6] shows a VNA measurement for this setup with up to four devices and a simulation with up to 32 devices.

The automotive use case defines a bus reach of at least 40 m. This allows a vehicle-spanning bus for most commercial vehicles including long trucks. Other use cases, e.g., an industrial one, come with different bus reach demands; system parameters might have to be aligned. For optical buses with several hundred meters reach or more, it is required to rethink the chosen OFDMA parameters. Radio systems like 4G demonstrate the suitability of OFDMA communication also for distances of several kilometers.

The OFDMA system concept is not limited to certain media. The described use case demands electrical links, but also would allow optical links using plastic optical fiber (POF). These need other AFEs for optical signal generation and detection, in particular ones with analog in- and output, not digitized as typical with limiting amplifiers. Optical media offer more bandwidth and thereby higher data rates. Reference [5] points out the suitability of orthogonal frequency division multiplex (OFDM) for industrial bus communication. OFDMA is a multiple access scheme on top of OFDM that enables multi-user resource allocation in the frequency domain by adding some complexity.

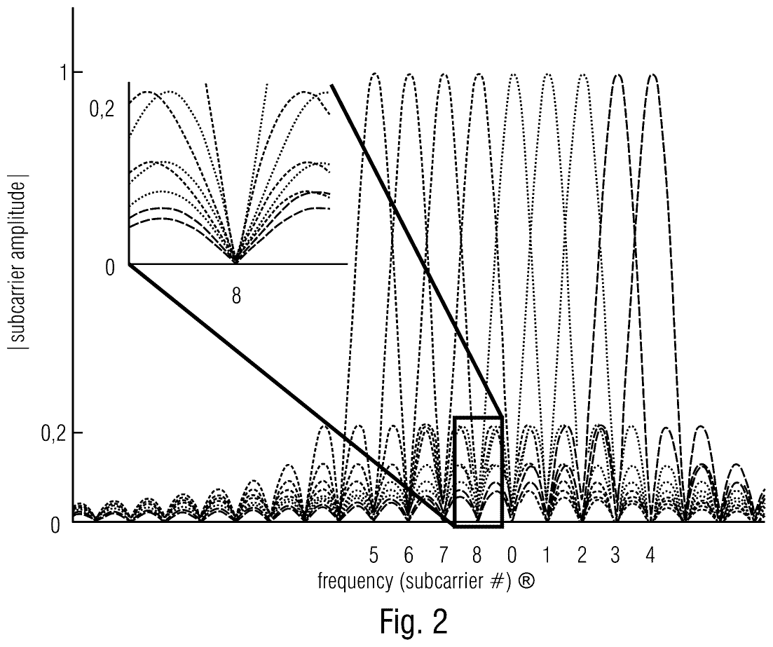

A goal of the PHY DSP is to divide the full signal band into several densely spaced, orthogonal sub-bands, called OFDM subcarriers (SCs). This approach offers superior channel adaptation compared to baseband and single-carrier transmission. Frequency orthogonality enables closely spaced SCs with overlapping spectra, while preventing interference between them: each subcarrier (SC) transports no power at mid-frequencies of all other system SCs. Inverse fast Fourier transformation (IFFT) can efficiently realize the SC generation. The modulation on different SCs is adaptable to the frequency-dependent channel response, influenced by attenuation, multipath propagation, noise and crosstalk. OFDMA offers to transmit data from various sources via different SCs within the same timeslot. FIG. 2 shows a simplified example power spectrum with nine power-normalized SCs from different sources.

The concept of the PHY DSP may consist of three sublayers, having a Tx and a Rx path each. Both higher PHY sublayers (201, 266), the physical medium attachment (PMA) and the physical coding sublayer (PCS) act as data source and sink interfacing the medium access layer (MAC) and apply bit stream scrambling and forward error correction (FEC). In the case of OFDMA, coding is applied for each link individually. Our focus in this section is the Physical Medium Dependent sublayer (PMD), whose DSP structure is shown in FIGS. 3a, 3b, 4a, 4b. The PMD executes signal modulation and demodulation. The Tone Mapper 204 successively takes bits 206 from the incoming stream 202, appropriate to the selected modulation format for each SC (subcarrier). The modulation format is decided by measuring the effective signal-to-noise-and-interference-ratio (SINR) for each SC at the physical layer, which is fed back to the transmitter yielding a fully adaptive system: the higher the SINR, the higher is the spectral efficiency of the quadrature amplitude modulation (QAM), yielding a higher throughput on that SC. This adaptive approach exploits the channel for each link individually compared to a non-frequency-multiplexed approach.

Bits 206 are forwarded to the QAM mapper 208. For OFDMA, the QAM symbols 210 are mapped onto those SCs assigned to an individual link, else the QAM mapper 208 outputs a zero-signal to leave the resources free for other links. SC assignment may follow a system wide resource allocation (RA) to be respected by all links. Regularly, data QAM symbols 210 are multiplexed (e.g. at multiplexer 216) with known channel estimation (CE) symbols 214 (e.g. provided by block 212) to enable equalization at the Rx (receiver). The stream of locally generated QAM symbols 210 (218) operating on different SCs in parallel are added at the end (e.g. in a block not shown between blocks 216 and 218) and the IFFT block 220 transforms these (218) into the time domain, generating so-called OFDM symbols 221. Distributed generated OFDM symbols 221 should finally be added up on the medium, building OFDMA symbols, still orthogonal when RA and common synchronization is regarded. Before passing them to the line through the Upshift-stage 234 and the DAC 238, two major steps enable orthogonal decoding at the Rx (receiver):
1.) Each OFDM symbol (210, 218, 221) is processed so as to contain a so-called cyclic prefix (CP) at CP insertion block 226, so that the version 227 of the OFDM symbol has the CP. The CP makes the signal robust against reflections on the bus where a fraction of the signal is tapped for every connected device. In MP2MP scenarios, distances between connected devices vary a lot. This is a special case of multipath propagation with a different propagation delay for each active link. All parallel signals for all links are jointly decoded and equalized in the frequency domain at the Rx later. The major condition therefore is that all signals arrive in a time window that is longer than the CP. If this condition is met, no inter-symbol interference (ISI) is expected. Reference [7] shows that ISI comes with loss of orthogonality for OFDM, OFDMA may have Tx-individual timing offsets (n_{ε} in [7]) for SCs at the Rx.
2.) Before bringing the signal to the transmission carrier frequency by the Upshift block 234, an Rx detectable synchronization sequence (SYN) may be added regularly, deliver timing information (249, 251) of the OFDM symbol 227 starts, as well as exact operation frequency information to the Rx. Note also that SYN 224 as well as RA need to follow a master-slave approach. Only one device (the master 10) shall add the synchronization sequence to realize local time synchronization at all other devices to avoid ISI (inter signal interference). All other devices 20 shall mute themselves and send their payload based on the locally retrieved time reference. Moreover, the master 10 shall organize the RA (resource allocation) process not discussed in detail here, i.e., send a beacon, ask for feedback and assign SC resources, accordingly. The master 10 functionality could be assigned to any device connected to the bus; it can be diced out or configured statically. In practice, where the device 20 of FIGS. 3a, 3b, 4a, 4b operates as SYNCC, the block SYN inserter block 222 and the multiplexer 230 are deactivated.

For simplicity, we assume no knowledge about device positions and the bus length, only the maximum bus length is specified. MP2MP-OFDMA then needs a CP lasting at least twice the propagation time for the maximum bus length, i.e., about 0.4 us for the upper defined reach of 40 m. It needs one bus length to cover the maximum propagation time from Tx to Rx for CE and data symbols, and another bus length to allow for local time synchronization based on SYN data traveled from the master to the Tx before. The CP could be further reduced by constraining the position of the master to the bus center. A so-called ranging protocol, see, e.g. [8], leading to a global time synchronization, and using pre-delayed signals could also be applicable. However, extending the ranging protocol to the MP2MP case is rather complicated and still to be investigated. We believe that it is better to cover the variable delays all within the extended CP.

Local time and sampling frequency might differ due to limited reference oscillators but needs to be exact to keep OFDM symbols and SCs orthogonal, respectively. In OFDM receivers, time and sampling frequency offset synchronization is often performed in a post-processing manner, e.g., described in [7]. We propose MP2MP-OFDMA time and frequency synchronization by detecting corresponding offsets between the master 10 and the local device 20 inside the local Rx's, e.g., with [9], and then tune the local Tx respectively; Not sending locally before Tx (transmission) is tuned leads to implicit system synchronicity. Time and frequency offset detection is done in the Rx (reception) SYN block 248 directly after down converting the signal 242 back to the complex baseband (e.g. by frequency downshift block 244, which provides the signal's baseband version 246). The following Fast Fourier Transform (FFT) (in FFT block 252) on signal's version 250 allows demodulation of all SCs signals from all devices 10 jointly, to reach signal's version 254. This is a very flexible and efficient method, especially for IVNs, containing many multicast messages. After the FFT (at FFT block 252), the SC signals 254 are passed through a frequency-domain equalizer (FDE) 256, which corrects the impact of the propagation channels. The FDE 256 first calculates for each SC 254 a channel coefficient by dividing the received by the transmitted reference signal from the CE sequence. Then, the FDE 256 reconstructs the received data signals 258 on each SC 254 by dividing the received signal on that SC by the corresponding channel coefficient. The tone de-mapper 263 reconstructs bitstream 264 for each link and passes it to the upper PHY sublayer 266 e.g. for FEC decoding. Tx bitstreams for other links are dropped and not forwarded to the upper PHY sublayers. Note that non-deterministic noise is amplified on bad SCs. It is measured by the error vector magnitude (EVM) in the QAM-demapper 260 (which provides signal's version 262). SC-related EVM or SINR is a major decision criterion for QAM modulation depth at the Tx (transmission), can be completed with FEC correction statistics. This information can also be fed back to the master device as an information to decide whether this SC is suitable for that link. In some cases, it is better to assign bad SCs to another link which has better channel quality on that SC. This is like the well-known multi-user diversity concept in wireless networks.

### Demonstrator

### Demonstrator Hardware

The demonstrator uses two identical communication nodes. System-on-chip (SoC) based DSP hardware combines a field programmable gate array (FPGA) and an ARM processor sub system (Trenz Electronic TE080X baseboard with a ZU7EV-1E module containing an AMD/Xilinx MPSoC). The ARM subsystem runs an embedded Linux interface to the FPGA for interaction with a control system. The baseboard is equipped with a Digital-to-Analog- and Analog-to-Digital-Converter (DAC and ADC) card (Vadatech FMC220). The ADC connects to the AFE through Direct Current (DC) blocking capacitors, removing signals below 5 MHz. It has 1 GSa/s and 12 bit resolution. The DAC is operated at 4 GSa/s and has 16 bit resolution, while the DSP chain runs at 1 GSa/s in the output stage, matched to the ADC specification. Up-sampling is done by the FPGA. DAC and ADC are synchronized. These specifications allow data processing for 250 MHz OFDMA signals. For initial testing, both nodes share the same reference clock, avoiding the need for frequency synchronization. Frequency offset detection methods are described, e.g., in [9]. We hint to the proposed method for frequency offset synchronization in MP2MP-OFDMA in above. Due to component availability, we just connect two nodes to the bus. The node distance is 2 m while the overall bus length is 3 m. Both bus ends are differentially terminated with 100Ω, matching the line impedance. For bigger bus setups, we hint to the simulations and VNA measurements in [6].

### Multiband OFDM Demonstrator

The demonstrator preprocesses the OFDM waveform by a MATLAB service program and loads it to the SoCs RAM. The DAC then plays the waveform out cyclically, after transfer through DMA to the FPGA subsystem. The DSP uses only 12 bits to reduce DMA implementation complexity. On the receive side, we capture the incoming sample stream at the ADC and store it on demand in the RAM. The MATLAB program downloads the RAM data through the ARM processor and performs the Rx DSP offline in MATLAB.

The DSP chain follows the design in FIGS. 3a, 3b, 4a, 4b with following limitations: Because synchronization sequence detection in real-time was not available, time-synchronous OFDM signal generation through different transmitters could not be ensured. As stated above, we therefore expect ISI. The same limitation required an individual synchronization for each Tx-Rx link. To solve this, we cross-correlated the received signal with the CE symbols and abandon the exclusive synchronization sequence shared by all transceivers. To keep the design flexible and close to the OFDMA system design, we use a full-size IFFT and FFT over the whole bandwidth. Therefore, only one Tx-signal band can be decoded by one Rx-PCS-DSP chain at the same time. Therefore, we call this setup “multiband OFDM” instead of OFDMA. As a non-synchronous OFDM system with concatenated spectra, out-of-band (OOB) emission from the neighbor OFDM signal is awaited (please see FIG. 2). Several mitigation techniques are known for OOB reduction, e.g. [10][11], but come with costs like in-band signal distortion and computational effort and are more suitable to environments interfering with external systems. Inherent avoidance of OOB influence is desirable, coming with a real-time OFDMA design.

System parameters for the demonstration can be chosen flexibly within the hardware limits (bandwidth, sample rate, resolution, and memory depth) by means of MATLAB processing. We show the system operating from DC to 250 MHz, 1024 SCs and a CP size of 128 samples per OFDM symbol, i.e., 512 ns on the bus. This is sufficient for all types of delays on the demonstrator bus, supporting a length up to about 50 m. We transmit 12 data OFDM symbols, preceded by two QPSK CE symbols. We used QPSK modulation on the used SCs and EVM measurements for blind SINR estimation.

### Measurement Results

We present per SC SINR estimation results based on blind EVM measurements for signal quality evaluation after passing the DSP and the exemplary automotive bus channel. An approximate relation between SNR and EVM is given in [12]. Assuming perfect equalization with in-phase and quadrature QPSK constellation amplitudes I₀ and Q₀ at ±1/\sqrt{2}, and that the nearest constellation point delivers correct data detection, what is highly probable for the resulting SINR values, the SINR on a SC measured in dB is approximately given by

$${SINR}_{d b , S C} \approx 10 \cdot {log}_{10} \frac{T}{{\sum }_{t = 1}^{T} {( \vert {I}_{t , SC} \vert - \frac{1}{\sqrt{2}} )}^{2} + {( \vert {Q}_{t , SC} \vert - \frac{1}{\sqrt{2}} )}^{2}} \qquad ( 1 )$$

where T represents the measurement set size of OFDM symbols, and I_{t,SC} and Q_{t,SC} are the measured in-phase and quadrature components of the equalized symbol received on the SC. Interference from alien sources and non-ideal decoding is both captured by the SINR definition given by Eq. (1).

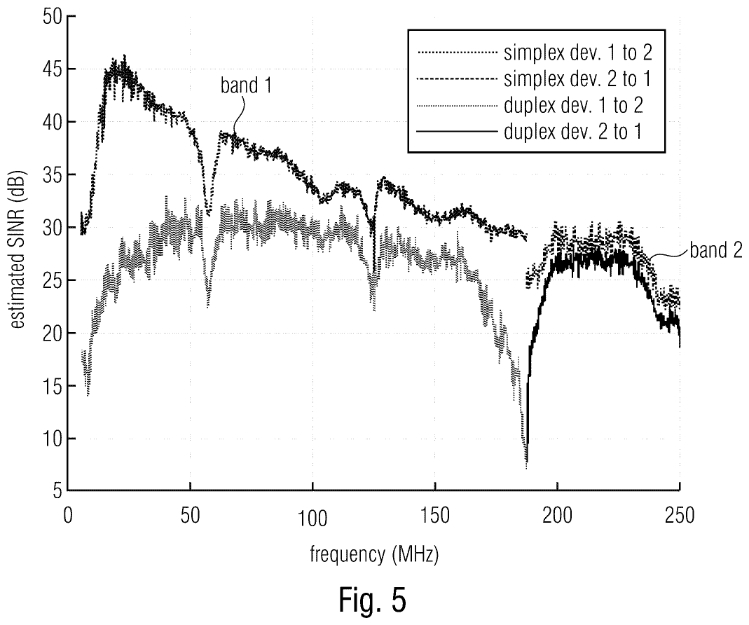

Two links are operated independently as described above: Band 1 transmits QPSK data from device 1 to device 2 through 744 SCs, in the frequency band from 5.86 to 187.5 MHz. Band 2 transmits QPSK data in opposite direction from 187.5 to 250 MHz using 256 SCs. The remaining 24 SCs are not in use, representing frequencies from DC up to 5.86 MHz, which are highly attenuated by DC-blocking capacitors in front of ADCs. FIG. 5 shows estimated SINR values for simplex transmission for band 1 (curve) and band 2 (curve) which is not according to the invention. In this measurement, while measuring one band, the other band was not active. These measurements were repeated with OFDM operation in duplex mode, thus both bands transmitted data at the same time, displayed by the yellow and the purple curve. Each value in the graph is averaged over T=600 received OFDM symbols.

FIG. 5 shows that higher signal quality is achieved with simplex compared to duplex transmission. Besides the low-pass characteristics (see [6]), we observe two major effects when comparing these results:
1.) Degradations in band 2 for frequencies above 187.5 MHz are smaller compared to lower frequencies in band 1 below 187.5 MHz, where degradation is much higher. Obviously, the effects are asymmetric, i.e., simultaneous transmission of band 2 interferes more with band 1 than vice versa. Further analysis indicates that this observation can be assigned to inter-symbol-interference (ISI) exceeding the allowed decoding window, as described in [7] for a single-band OFDM signal occupying all SCs. For multi-band OFDM and OFDMA, this issue occurs inherently when signals are not properly synchronized. After adding up the signals on the bus, when sent without appropriate time synchronization, the CP from band 1 worked mostly for band 2, starting the transmission at random time (N_{g} from [7] is within the accepted window [−N_{g};0] for all SCs). The receiver of device 1 observes (at least almost) one valid “OFDMA symbol” over the whole band. In the opposite link direction, the receiver of device 2 observes the correct window for OFDM symbol demodulation for the lower frequency SCs in band 1, based on its own synchronization mechanism. For the other band, however, the receiver observes data from two successive OFDM symbols. The underlying OFDM physical layer is therefore no longer able to distinguish the alien upper band signal from the desired lower band signal; some signal from the upper band spreads into the lower band signals, acting like random unpredictable interference and reduces the SINR in the lower band. Without sufficient inter-device time synchronization, and a CP of ⅛ of the OFDM symbol length, ISI is highly likely, for the receiver of device 1, for the receiver of device 2, or for both.
2.) We observe a significant drop of signal quality around 187.5 MHz, where both bands touch each other. While orthogonality is ensured in a time- and frequency-synchronous OFDMA system, this is lost in the asynchronous case. Zero-power at the center frequency of neighboring SCs is no longer ensured, i.e., OOB emission occurs. Since most OOB power results from neighboring SCs of the asynchronous band, the effect fades with increasing frequency distance. For mitigation of OOB emission, especially at the band edges, a guard band could be introduced by transmitting zero power on the band edges of SCs in the neighborhood to foreign bands. Although this might reduce the observed effects, it would reduce the spectral efficiency of the OFDMA system. The loss of SCs for data transmission would be traded against an improved signal quality respectively, which should better be realized by proper synchronization among the devices on the bus.

### CONCLUSION AND OUTLOOK

A flexible scalable automotive OFDMA high-speed bus system is proposed, offering IVN complexity reduction under various aspects. The system concept is presented, focusing on the PHY layer DSP for a MP2MP-OFDMA system. While the building blocks are similar to those in common P2MP-OFDM and -ODFMA systems, MP2MP-OFDMA DSP needs to reconsider some rules for synchronization. The cyclic prefix is related to twice the bus length and the synchronization preamble shall be sent only by one master device which can be randomly chosen among all devices connected to the bus. An offline-DSP demonstrator using an automotive UTP channel illustrated the need for proper device time synchronization and demonstrated major interference effects for asynchronous operation. Since offline DSP cannot fulfill the synchronization needs, future work will include the implementation of a real-time DSP and demonstrate the OFDMA concept under real conditions. One goal is to measure the achievable data rates and quantify the advantages of OFDMA over the time-multiplexed transmission in Automotive Ethernet.

### Further Characterization of FIG. 14:

For easiness of example, following assumptions:
#IFFTs 220 and FFTs 252 are configured to generate real valued outputs,
From ##(218): data to be sent, that is constant per device, leading to the signals 612A-612C from the SYNCM 10 and the signal 512A, 512B, 512C from the SYNCC 20
###(234, 242) post processing blocks after point “R” will apply neutral actions (generally, they apply actions with fixed known delays) to make the data between the points “R” (230) and the outputs comparable
4 #SYN detect block (248) can deliver perfect results and tune the Tx perfectly
5 #channel e.g. without multiple propagation paths

### Further Characterization of FIG. 16A-16G:

t_{SYNCLEN}*: the mark 591 applies when an optional pause of 2*t_{D} is inserted to prevent interference of SYN from delayed, previous signals. It belongs to t_{SYNCLEN}
“R”: please compare invention description the DSP processing point “R” in every device (SYNCM and SYNCCs), where the action “S” is performed leading
To the output of the next OFDMA symbol portion.

### Summarizing Aspects

The communication device (e.g. 20) may be for an OFDMA communication [e.g. multipoint-to-multipoint], configured to receive and transmit OFDMA signals (e.g. in OFDMA symbols),
wherein the communication device is configured to receive a periodic synchronization signal [e.g. from a master communication device] [e.g. the periodic reception of the synchronization signal may be cyclical, and/or may be in a synchronization subperiod]
wherein the communication device is configured to derive a transmission characteristic [e.g. timing, frequency, sample clock] on the basis of the received synchronization signal and to adapt a subsequent transmission [e.g. from the communication device] to the derived transmission characteristic.
[e.g. the periodic synchronization signal is therefore according to a streaming technique, in which the periodic synchronization signal is notwithstanding periodically transmitted even if no other communication device is transmitting anything]
[in examples, after the reception of the synchronization signal (in a synchronization subperiod), there can start an OFDMA subperiod, during which the communication device, together with other communication devices, transmits transmissions, including the subsequent transmission, and/or receives transmissions, from the master communication device and/or from any other communication device, the transmissions, both in transmission and in reception, being synchronized to the transmission characteristic derived from the synchronization signal].

The communication device may generate the subsequent transmission as including a sequence of OFDMA symbols [e.g. the sequence of OFDMA symbols occupying the OFDMA subperiod], and configured to:
generate, for each OFDMA symbol of the sequence of OFDMA symbols, an initial cyclic extension (e.g. cyclic prefix) in which there are copied the last samples of the OFDMA symbol [e.g. so that between the cyclic prefix and the remaining part of the OFDMA symbol there is no step, thereby obtaining a continuous shape of the OFDMA symbol and without interference between with the immediately preceding and/or immediately subsequent OFDMA symbol], and/or
generate, for each OFDMA symbol of the sequence of OFDMA symbols, a final cyclic extension in which there are copied the first samples of the OFDMA symbol [e.g. so that between the cyclic extension and the remaining part of the OFDMA symbol there is no step, thereby obtaining a continuous shape of the OFDMA symbol and without interference between with the immediately preceding and/or immediately subsequent OFDMA symbol].

The communication device may derive a transmission characteristic [e.g. timing, frequency, sample clock] on the basis of the received synchronization signal and to adapt a subsequent transmission [e.g. from the communication device] to the derived transmission characteristic.

The communication device may determine the transmission characteristic as comprising timing information.

The communication device may determine the transmission characteristic as comprising information (e.g. timing information) for resynchronizing its internal clock.

The communication device may determine the transmission characteristic as comprising subcarrier frequency [and/or subcarrier frequency offset] and/or carrier frequency [and/or carrier frequency offset].

The communication device may determine the transmission characteristic as comprising sampling frequency [and/or sampling frequency offset].

The communication device may receive the synchronization signal as a periodic signal [and/or a signal with a fixed distance from the immediately preceding and/or immediately subsequent OFDMA symbol portion].

[e.g. more in general, the time may be cyclically, e.g. periodically, defined in a time period (e.g. with time length t_{TI_CYC}), which may be cyclically (e.g., periodically) divided (e.g. non-superposably divided and/or subdivided in adjacent subperiods) subdivided between a synchronization subperiod (e.g. slot) (e.g. having time length t_{TI_SYNCLEN}) and a OFDMA symbol subperiod (e.g. slot), e.g. payload subperiod (e.g. slot), so that the OFDMA symbols of the payload are received in the OFDMA symbol subperiod (e.g. starting at time instant t_{TI_SYM1} after the start or the end of the synchronization subperiod), and in the synchronization subperiod the communication device receives the synchronization signal, so as to derive the transmission characteristic [e.g. timing, frequency, sample clock] from the synchronization signal in the synchronization subperiod].

The communication device may receive the synchronization signal as comprising a known sequence of OFDMA symbols, and/or the communication device being configured to determine the transmission characteristic [e.g. timing, frequency, sample clock] on the basis of the received known sequence of OFDMA symbols].

The communication device may receive the synchronization signal as comprising a known sequence of samples (e.g. baseband symbols), and/or configured to determine the transmission characteristic [e.g. timing, frequency, sample clock] on the basis of the received known sequence of, e.g. OFDMA symbols] [e.g. this technique is in particular, but not necessarily uniquely, devoted to derive the transmission characteristic as sampling rate].

The communication device may evaluate the difference between the current sample frequency (e.g. baseband frequency) and the frequency as determined from the synchronization signal, to thereby adapt the sample frequency by adopting a new sampling frequency compensating the difference between the current frequency and the frequency as determined from the synchronization signal.

The communication device may receive the synchronization signal as comprising at least one carrier or subcarrier [e.g. according to a known sequence of carriers of subcarriers, in case of multiple carriers of subcarriers], and/or the communication device being configured to determine the transmission characteristic [e.g. timing, frequency, sample clock] on the basis of the received at least one carrier or subcarrier [e.g. the known sequence of carriers of subcarriers, in case of multiple carriers of subcarriers], so as to adapt the subsequent transmission to the derived frequency or frequency offset of the received carrier or subcarrier(s) [e.g. this technique is in particular, but not necessarily uniquely, devoted to derive the transmission characteristic as carrier frequency rate and/or to perform carrier frequency synchronization] [e.g. according to some aspects, the time difference between the at least one carrier or subcarrier may permit to evaluate the carrier frequency offset or subcarrier frequency offset, so as to adapt the transmission characteristic (e.g. timing, frequency, sample clock) to compensate the carrier frequency offset or subcarrier frequency offset].

The communication device may refrain from transmitting any signal during the reception of the synchronization signal [and/or during the synchronization subperiod].

The communication device may receive, in the synchronization signal, a sequence of symbols [e.g. ODFMA symbols, symbols, carriers, subcarriers, samples etc.], so as to derive time difference information between the reception of symbols of the sequence of symbols and the assumed time of reception of the symbols of the sequence of symbols, thereby deriving the transmission characteristic [e.g. timing, frequency, carrier, sample clock] from the time difference information] [e.g. according to some aspects, the time difference information between the at least one carrier or subcarrier may permit to evaluate the symbol frequency offset, so as to adapt the transmission characteristic (e.g. timing, frequency, sample clock) to compensate the symbol frequency offset].

The communication device may derive the transmission characteristic [e.g. timing, frequency, sample clock] by evaluating at least one time distance (e.g. STO) [or a metrics providing an aggregate information on distances] between at least one symbol [e.g. sample] received in the synchronization signal and an assumed time point based on the current transmission characteristic.

The communication device may evaluate the at least one time distance by performing a cross correlation with at least one pre-defined sample.

The communication device may evaluate the difference between a current frequency (e.g. timing frequency, symbol frequency, sample clock, sampling frequency) and a frequency (e.g. timing frequency, symbol frequency, sample clock, sampling frequency) of the synchronization signal, to thereby adapt the transmission frequency [e.g. for both transmission and reception] of a subsequent transmission from the communication device by adopting a new frequency which compensates for the difference between the current frequency and the frequency as determined from the synchronization signal [e.g. if the difference is positive, then the compensation will be negative, and if the difference is negative, then the compensation will be positive] [e.g. the larger the difference, the larger the compensation, and the smaller the difference, the smaller the compensation].

The communication device may transmit and/or receive at least one transmission signal [e.g. the subsequent transmission signal] to include, in an initial guard time of a ODFMA symbol, a repetition of a final portion of the ODFMA symbol and/or include, in a final guard time of a ODFMA symbol, a repetition of an initial portion of the ODFMA symbol.

The communication device may process the received synchronization signal to thereby derive [e.g. and update] the transmission characteristic, while transmitting the subsequent transmission using at least one initial symbol [e.g. OFDMA symbol] based on a non-updated, previously obtained transmission characteristic [e.g. derived at the immediately preceding period from the preceding synchronization signal], and, after having updated the transmission characteristic, to use the transmission characteristic for the remaining symbols [e.g. OFDMA symbols] of the same, subsequent transmission [therefore, it may happen that in the OFDMA subperiod the synchronization is updated, and/or the initial OFDM symbols of the subsequent transmission have a different synchronization from the final OFDM symbols of the subsequent transmission].

The communication device may perform:
a first, rough synchronization, [e.g. based on the transmission characteristic e.g. based on the time difference between the assumed reception of a symbol and the actual reception of the symbol of the synchronization signal], so as to derive a frequency offset, and compensate for a frequency offset, and/or
a second, fine synchronization, to derive the time instant to send an OFDMA symbol.

The communication device may receive signals, included the synchronization signal, and transmit signals, as wired signals.

The communication device may receive signals, included the synchronization signal, and transmit signals, as wireless signals.

The communication device may receive signals, included the synchronization signal, and transmit signals, as optical signals.

The communication device may receive signals, included the synchronization signal, and transmit signals, as radio frequency signals.

The communication device may receive signals, included the synchronization signal, and transmit signals, as ultrasound signals.

The communication device may determine the transmission characteristic from the synchronization signal in time domain, and to adapt the transmission characteristic of the transmitted signal in the time domain.

The communication device may participate to a master election among a plurality of other communication devices, so as, in case the communication device is elected as master communication device, to deactivate the determination of the transmission characteristic and the adaptation of the transmission characteristic.

The communication device may send and receive transmissions according to a scheduling [e.g. the scheduling could be defined by the master device]

The communication device may wait, before sending subsequent transmission [e.g. in a OFDMA slot in which an OFDMA symbol is to be transmitted], for a propagation time [e.g. 2*t_{D}] which keeps into account both the propagation delay from the master communication device to the communication device (t_{PROP1}) and the propagation delay (t_{PROP2}) from the communication device to the master communication device or another communication device. [Other communication devices are simultaneously transmitting ODFMA symbols of orthogonal OFDMA signals, and since all of them respect this rule, OFDMA symbols appear superposed with each other]

The communication device may derive the transmission characteristic [e.g. timing, frequency, sample clock] on the basis of the received synchronization signal and to adapt the synchronization of the reception of at least one subsequent received OFDMA signal and/or OFDMA symbol [e.g. from the master communication device and/or from other communication devices synchronized to the master communication device] to the derived transmission characteristic [e.g. the communication device may also adapt the a subsequent transmission on the basis of the received synchronization signal and to adapt a subsequent transmission (e.g. from the communication device to the master communication device and/or to another communication device also synchronized to the master communication device) to the derived transmission characteristic].

The communication device may define a time domain decoding window [e.g. of the time length which may be, in number of samples, associated with (e.g. the same of, which maybe a 20% of tolerance) the number of OFDMA signals (e.g. OFDMA orthogonal sequences) which may be defined in the communication], the time domain decoding window being positioned on a OFDMA symbol slot (e.g. in a slot which is meant at hosting a OFDMA symbol) [e.g. once the decoding window is defined, it is possible to decode the particular OFDMA symbol within the decoding window] [in examples, in case the OFDMA symbol has been generated by a communication device, once the decoding window is positioned on the OFDMA symbol the operation of decoding the ODFMA symbol is advantaged, since there is no step in the received signal by virtue of the repetition of the samples, and the OFDMA symbol may be accordingly more easily decoded (e.g. steps would imply any kind of harmonics, which would therefore complicated the decoding)].

There is provided an electronic unit comprising a communication device according to any of the preceding examples.

The electronic unit may encode at least one sensed value [e.g. obtained from a sensor, e.g. comprised in the electronic unit] in the at least one subsequent transmission.

The electronic unit may control at least one actuation [e.g. performed by an actuator, e.g. comprised in the electronic unit] from at least one received transmission.

The electronic unit may control at least one other electronic unit, and further configured to transmit a control information to the at least one other electronic unit through the at least one subsequent transmission.

There is provided a system [e.g. for multipoint to multipoint communication] comprising:
a master communication device; and
at least one client communication device (e.g., at least one plurality of client communication devices),
wherein the master communication device is configured to transmit a periodic synchronization signal [e.g. the periodic reception of the synchronization signal may be cyclical, and/or may be in a synchronization subperiod]
wherein the at least one client communication device is configured to derive a transmission characteristic [e.g. timing, frequency, carrier, sample clock] on the basis of the received synchronization signal and to adapt a subsequent transmission [from the communication device] to the derived transmission characteristic.

The at least one client communication device may be a communication device according to any of the examples below.

The master communication device may be further configured [e.g. in an OFDMA subperiod], to
generate, for each OFDMA symbol of the sequence of OFDMA symbols, an initial cyclic extension (e.g. cyclic prefix) in which there are copied the last samples of the OFDMA symbol [e.g. so that between the cyclic prefix and the remaining part of the OFDMA symbol there is no step, thereby obtaining a continuous shape of the OFDMA symbol and without interference between with the immediately preceding and/or immediately subsequent OFDMA symbol], and/or
generate, for each OFDMA symbol of the sequence of OFDMA symbols, a final cyclic extension in which there are copied the first samples of the OFDMA symbol [e.g. so that between the cyclic extension and the remaining part of the OFDMA symbol there is no step, thereby obtaining a continuous shape of the OFDMA symbol and without interference between with the immediately preceding and/or immediately subsequent OFDMA symbol].

The master communication device may be configured [e.g. in an OFDMA subperiod] to define a time domain decoding window [e.g. of the time length which may be, in number of samples, associated with (e.g. the same of, which maybe a 20% of tolerance) the number of OFDMA signals (e.g. OFDMA orthogonal sequences) which may be defined in the communication], the time domain decoding window being positioned on a OFDMA symbol slot (e.g. in a slot which is meant at hosting a slot) [once the decoding window is defined, it is possible to decode the particular OFDMA symbol within the decoding window] [in examples, once the decoding window is positioned on the OFDMA symbol the operation of decoding the ODFMA symbol is advantaged, since there is no step in the received signal by virtue of the repetition of the samples, and the OFDMA symbol may be accordingly more easily decoded (e.g. steps would imply any kind of harmonics, which would therefore complicated the decoding)].
[e.g. in any of the claims above, after the reception of the synchronization signal (e.g. in a synchronization subperiod), there can start an OFDMA subperiod, during which the communication device, together with other communication devices, transmits transmissions, including the subsequent transmission, and/or receives transmissions, form the master communication device and/or from any other communication device, the transmissions, both in transmission and in reception, being synchronized to the transmission characteristic derived from the synchronization signal].

A method [e.g. for a communication device, e.g. a client communication device, as any of the preceding claims] for an OFDMA communication [e.g. multipoint-to-multipoint communication], may include:
receiving a periodic synchronization signal [e.g. from a master communication device] [the periodic reception of the synchronization signal may be cyclical, and/or may be in a synchronization subperiod]
deriving a transmission characteristic [e.g. timing, frequency, sample clock] on the basis of the received synchronization signal and adapting a subsequent transmission [e.g. from the communication device] to the derived transmission characteristic.

A non-transitory storage unit storing instruction which, when executed by a processor may cause the processor to control the method of the above method.

### Further Examples

Generally, examples may be implemented as a computer program product with program instructions, the program instructions being operative for performing one of the methods when the computer program product runs on a computer. The program instructions may for example be stored on a machine readable medium.

Other examples comprise the computer program for performing one of the methods described herein, stored on a machine readable carrier.

In other words, an example of method is, therefore, a computer program having a program instructions for performing one of the methods described herein, when the computer program runs on a computer.

A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory.

A further example of the method is, therefore, a data stream or a sequence of signals representing the computer program for performing one of the methods described herein. The data stream or the sequence of signals may for example be transferred via a data communication connection, for example via the Internet.

A further example comprises a processing means, for example a computer, or a programmable logic device performing one of the methods described herein.

A further example comprises a computer having installed thereon the computer program for performing one of the methods described herein.

A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus.

The above described examples are merely illustrative for the principles discussed above. It is understood that modifications and variations of the arrangements and the details described herein will be apparent. It is the intent, therefore, to be limited by the scope of the impending claims and not by the specific details presented by way of description and explanation of the examples herein.

Equal or equivalent elements or elements with equal or equivalent functionality are denoted in the following description by equal or equivalent reference numerals even if occurring in different figures.

While this invention has been described in terms of several embodiments, there are al-terations, permutations, and equivalents which fall within the scope of this invention. It should also be noted that there are many alternative ways of implementing the methods and compositions of the present invention. It is therefore intended that the following ap-pended claims be interpreted as including all such alterations, permutations and equivalents as fall within the true spirit and scope of the present invention.

### REFERENCES

[1] N. Navet and F. Simonot-Lion, “In-vehicle communication networks-a historical perspective and review”, in Industrial Communication Technology Handbook, Second Edition, R. Zurawski, Ed., CRC Press Taylor&Francis, 2013.
[2] S. Tuohy, M. Glavin, C. Hughes, E. Jones, M. Trivedi and L. Kilmartin, “Intra-Vehicle Networks: A Review”, IEEE Transactions on Intelligent Transportation Systems, vol. 16, p. 534-545, April 2015.
[3] D. Stöhrmann, A. Kostrzewa, R. Ernst and H. Kellermann, “Towards OFDMA-based Ethernet for future in-vehicle communication”, in 2020 2nd International Conference on Societal Automation (SA), 2021.
[4] “IEEE Standard for Ethernet,” IEEE Std 802.3-2022 (Revision of IEEE Std 802.3-2018), pp. 1-7025, 2022.
[5] J. L. González Rios, J. Torres Gómez, R. K. Sharma, F. Dressler and M. J. Fernández-Getino García, “Wideband OFDM-Based Communications in Bus Topology as a Key Enabler for Industry 4.0 Networks”, IEEE Access, vol. 9, p. 114167-114178, 2021.
[6] R. K. Sharma, S. Cheraghinav, F. Khairaldin, M. Freund and G. Hirtz, “Characterization and Simulation of an OFDM-Based Automotive Bus System”, in 2020 2nd International Conference on Societal Automation (SA), 2021.
[7] M. Speth, S. A. Fechtel, G. Fock and H. Meyr, “Optimum receiver design for wireless broad-band systems using OFDM. I”, IEEE Transactions on Communications, vol. 47, pp. 1668-1677, 1999.
[8] X. Fu and H. Minn, “Initial uplink synchronization and power control (ranging process) for OFDMA systems”, in IEEE Global Telecommunications Conference, 2004. GLOBECOM '04.
[9] H. Minn, V. K. Bhargava and K. B. Letaief, “A robust timing and frequency synchronization for OFDM systems,” IEEE Transactions on Wireless Communications, vol. 24, p. 822-839, May 2003.
[10] I. Cosovic, S. Brandes and M. Schnell, “A technique for sidelobe suppression in OFDM systems”, in IEEE Global Telecommunications Conference 2005, GLOBECOM '05.
[11] H. A. Mahmoud and H. Arslan, “Sidelobe suppression in OFDM-based spectrum sharing systems using adaptive symbol transition”, IEEE Communications Letters, vol. 12, p. 133-135, February 2008.
[12] R. A. Shafik, M. S. Rahman and A. R. Islam, “On the Extended Relationships Among EVM, BER and SNR as Performance Metrics”, in 2006 International Conference on Electrical and Computer Engineering, 2006.
Continental Automotive GmbH, “ERIKA project website”, [Online]. Available: https://www.erika-projekt.de/. [Accessed 9 May 2023].

What is claimed:

1. A communication device for multipoint-to-multipoint OFDMA communication, configured to receive and transmit OFDMA signals,
wherein the communication device is configured to receive a periodic synchronization signal,
wherein the communication device is configured to derive a transmission characteristic on the basis of the received synchronization signal and to adapt a subsequent transmission to the derived transmission characteristic.

2. The communication device of claim 1, wherein the communication device is configured to generate the subsequent transmission as including a sequence of OFDMA symbols, and is further configured to:
generate, for each OFDMA symbol of the sequence of OFDMA symbols, an initial cyclic extension in which there are copied the last samples of the OFDMA symbol, and/or
generate, for each OFDMA symbol of the sequence of OFDMA symbols, a final cyclic extension in which there are copied the first samples of the OFDMA symbol,
wherein the communication device is configured to insert a number of samples, in the initial and/or final cyclic extension, which require a time length which covers the time length of a first propagation delay from the master communication device to the most remote communication device location allowed and a second propagation delay from the most remote communication device location allowed to the master communication device.

3. The communication device of claim 1, further configured to include, in an initial guard time of an OFDMA symbol of the sequence of OFDMA symbols, the initial cyclic extension as a repetition of a final portion of the OFDMA symbol and/or include, in a final guard time of the OFDMA symbol of the sequence of OFDMA symbols, the final cyclic extension as a repetition of an initial portion of the OFDMA symbol,
wherein the communication device is configured to determine the transmission characteristic as comprising sampling frequency.

4. The communication device of claim 1, configured to determine the transmission characteristic as comprising sampling frequency.

5. The communication device of claim 1, configured to determine the transmission characteristic as comprising sampling frequency, wherein the communication device is configured to evaluate a difference between a current sampling frequency, or an information associated with the current sampling frequency, and a frequency as determined from the synchronization signal, or an information associated with the frequency as determined from the synchronization signal, to thereby adapt the sampling frequency by adopting a new sampling frequency compensating the difference between the current sampling frequency, or the information associated with the current sampling frequency, and the frequency as determined from the synchronization signal, or the information associated with the frequency as determined from the synchronization signal.

6. The communication device of claim 1, configured to transmit at least one OFDMA symbol during the reception of the synchronization signal.

7. The communication device of claim 1, configured to perform an equalization operation using, as reference, a pilot tone simultaneous to OFDMA symbols.

8. The communication device of claim 7, configured to receive a plurality of pilot tones, simultaneous to OFDMA symbols which are not simultaneous to the synchronization signal, which comprise different frequency from each other.

9. The communication device of claim 1, configured to receive, in the synchronization signal, a sequence of symbols, so as to derive time difference information between the reception of symbols of the sequence of symbols and an assumed time of reception of the symbols of the sequence of symbols, thereby deriving the transmission characteristic.

10. The communication device of claim 1, configured to determine the transmission characteristic as comprising a frequency, wherein communication device is configured to derive the transmission characteristic by evaluating at least one time distance between at least one symbol received in the synchronization signal and an assumed time point based on the current transmission characteristic.

11. The communication device of claim 1, configured to determine the transmission characteristic as comprising a frequency, wherein the communication device is configured to evaluate a difference between a current frequency and a frequency of the synchronization signal, to thereby adapt the frequency of a subsequent transmission from the communication device by adopting a new frequency which compensates for the difference between the current frequency and the frequency of the synchronization signal.

12. The communication device of claim 1, configured to process the received synchronization signal to thereby derive the transmission characteristic, while transmitting the subsequent transmission using at least one initial symbol based on a non-updated, previously obtained transmission characteristic, and, after having updated the transmission characteristic, to use the transmission characteristic for the remaining symbols of the same, subsequent transmission.

13. The communication device of claim 1, configured:
to derive a frequency offset as the transmission characteristic or part of the transmission characteristic, and compensate for a frequency offset, and
to derive a time instant to send an OFDMA symbol as the transmission characteristic or part of the transmission characteristic.

14. The communication device of claim 13, configured to derive the frequency offset, and compensate for the frequency offset, downstream to deriving the time instant to send an OFDMA symbol, wherein the deriving of the frequency offset and the deriving of the time instant to send an OFDMA symbol are interposed by an FFT block.

15. The communication device of claim 1, configured to receive signals, included the synchronization signal, and transmit signals, as wired signals or optical signals.

16. The communication device of claim 1, configured to participate to a master election among a plurality of other communication devices, so as, in case the communication device is elected as master communication device, to deactivate the determination of the transmission characteristic and the adaptation of the transmission characteristic.

17. The communication device of claim 1, configured to define, taking into account the transmission characteristic, a time domain decoding window, the time domain decoding window being positioned on an OFDMA symbol slot, for decoding the OFDMA symbol in the OFDMA symbol slot.

18. The communication device of claim 1, further configured to encode at least one sensed value in the at least one subsequent transmission.

19. The communication device of claim 1, further configured to control at least one actuation based on at least one received transmission.

20. A system for multipoint-to-multipoint OFDMA communication, comprising:
a master communication device; and
N client communication devices, with N≥1, wherein the N communication devices are configured to receive and transmit OFDMA signals,
wherein the master communication device is configured to transmit the periodic synchronization signal and the N client communication devices are configured to receive the periodic synchronization signal;
wherein each of the N client communication devices is configured to derive a transmission characteristic on the basis of the received synchronization signal and to adapt a subsequent transmission to the derived transmission characteristic,
wherein the master communication device and each of the N client communication devices is further configured:
to generate, for each OFDMA symbol of the sequence of OFDMA symbols, an initial cyclic extension in which there are copied the last samples of the OFDMA symbol,
and/or
to generate, for each OFDMA symbol of the sequence of OFDMA symbols, a final cyclic extension in which there are copied the first samples of the OFDMA symbol,
in such a way that there is inserted a number of samples, in the initial and/or final cyclic extension, which require a time length which covers both:
a first propagation delay
from the master communication device
to the client communication device which, among the N client communication devices, is the most remote from the master communication device; and
a second propagation delay
from the communication device which, among the N client communication devices, is the most remote from the master communication device,
to the master communication device.
